(19) United States
(12) Patent Application Publication
(10) Pub. No.: US 2019/0122150 A1
(43) Pub. Date: Apr. 25, 2019

(54) SYSTEM AND METHOD FOR CONSULTING TO IDENTIFY VULNERABILITIES AND RECOMMENDING SOLUTIONS FOR SAME

(71) Applicant: Critical Ops, LLC, Westlake, OH (US)

(72) Inventors: Chelsea A. Treboniak, Westlake, OH (US); Chad A. Treboniak, Westlake, OH (US)

(21) Appl. No.: 16/167,619

(22) Filed: Oct. 23, 2018

Related U.S. Application Data
(60) Provisional application No. 62/576,261, filed on Oct. 24, 2017.
(60) Provisional application No. 62/640,235, filed on Mar. 8, 2018.

(51) Int. Cl. G06Q 10/06; G06F 17/30

(52) U.S. Cl. CPC G06Q 10/0635; G06F 17/30991; G06Q 10/06395; G06Q 10/06398

(57) ABSTRACT

A system and method for addressing emergency or non-emergency vulnerabilities is provided. The system and method may utilize a game or role-playing scenario that invokes responses by participants of the game or role-playing scenario. A provider evaluates the responses to address the vulnerabilities and provide potential solutions to the same. In some examples, the responses are evaluated and utilized to generate a summary that includes various action calls or products to eliminate, mitigate, or reduce the likelihood of the vulnerability. The action calls or products may include periodicals to read, products to use, or activities to perform. The summary may be generated manually or through the use of an automated process that efficiently evaluates the responses from the game or role-playing scenario.

### CROSS REFERENCE TO RELATED APPLICATIONS

This application claims the benefit of U.S. Provisional Patent Application Ser. No. 62/576,261, filed Oct. 24, 2017, and U.S. Provisional Patent Application Ser. No. 62/640,235, filed Mar. 8, 2018; the entire specification of each of which is incorporated herein by reference.

### BACKGROUND

### Technical Field

The present disclosure relates generally to consulting systems for identifying vulnerabilities and providing suggestions or recommendations to lessen the vulnerabilities, or at least reduce the potential risk thereof. More particularly, the present disclosure relates to a system and method for identifying vulnerabilities relating to different scenarios and providing suggestions or implementations that can alleviate those located vulnerabilities.

### Background Information

The U. S. Department of Homeland Security, Federal Emergency Management Agency (FEMA) provides information on threat and hazard identification and risk assessment (THIRA). Furthermore, FEMA indicates that the National Incident Management System may be used by an entire community. In one example, an intended audience for this FEMA THIRA is individuals, families, communities, private and nonprofit sectors, faith-based organizations, and local, state, tribal, territorial, insular area, and federal governments.

The FEMA THIRA program is a four-step common risk assessment process that helps a community understand its risks and estimate capability requirements. The THIRA process helps communities map their risks to the core capabilities, enabling them to determine whole community informed desired outcomes, capability targets, and resources required to achieve their capability targets.

The output of the THIRA process informs a variety of emergency management efforts, including emergency operations planning, mutual aid agreements, and hazard mitigation planning. Ultimately, the THIRA process helps communities answer the following questions: What do we need to prepare for? What shareable resources are required in order to be prepared? What actions could be employed in order to avoid, divert, lessen, or eliminate a threat or hazard?

While the THIRA process may be beneficial from a broad prospective, it does not always filter down and adequately identify specific performance results inasmuch as the THIRA process can have limited involvement from its participants.

### SUMMARY

Issues continue to exist with threat and hazard risk assessment programs, such as the THIRA process offered by FEMA. In one particular example, a need continues to exist for an improved risk assessment program to identify hazards by more actively engaging participants, especially with localized concerns that require specific stakeholder attention. Once the active participants in a program or process have identified the risks, then there needs to be a compilation process to provide the information to the operator or implementer of the process in a concise and detailed manner so that they may effectively address the identified risks based on recommendations provided to them that have been tailored to the identified risks. The present disclosure addresses these and other issues by providing a system and method for consulting a customer, entity, or group of people regarding a vulnerability assessment and recommending solutions for the same.

In one aspect, the present disclosure may provide a system for providing recommendations to address vulnerabilities comprising: a provider and a customer in operative communication via a link; a scenario prompt provided by the provider to the customer across the link; wherein the scenario prompt includes an emergency or non-emergency scenario to generate a series of responses by the customer which are provided back to the provider across the link after completion of the scenario prompt; and a summary having at least one of an activity, a product, and an article or periodical to address a vulnerability identified after the completion of the scenario prompt.

In another aspect, an exemplary embodiment of the present disclosure may provide a system for providing recommendations to address vulnerabilities comprising: a provider and a customer in operative communication via a link; a scenario prompt provided by the provider to the customer across the link; wherein the scenario prompt includes an emergency or non-emergency scenario to generate a series of responses by the customer which are provided back to the provider across the link; and a summary having at least one of an activity, article/periodical, and/or product to recommend a solution to a vulnerability identified by the provider based, at least in part, on the completion of the scenario prompt that may include the means, relationships and/or industry know-how to perform the follow-on activities. This exemplary embodiment or another exemplary embodiment may further provide a first activity that recommends solutions to the scenario prompt in response to the series of responses sent across the link. This exemplary embodiment or another exemplary embodiment may further provide wherein the first activity teaches the customer to perform actions quick in response to the identified vulnerability. This exemplary embodiment or another exemplary embodiment may further provide wherein the first activity teaches employees of the customer to leave their belongings behind in the event of an emergency. This exemplary embodiment or another exemplary embodiment may further provide a recommendation for a product that reduces the likelihood of damage from the identified vulnerability. This exemplary embodiment or another exemplary embodiment may further provide reading materials for the customer to read on topics pertaining to the identified vulnerability. This exemplary embodiment or another exemplary embodiment may further provide an activity to be performed by persons associated with the customer subsequent the scenario prompt operative to further teach the persons associated with the customer to take appropriate actions in response an event in which the identified vulnerability actually occurs.

In yet another aspect, an exemplary embodiment of the present disclosure may provide a system for providing recommendations to address vulnerabilities comprising: a provider and a customer in operative communication via a link; a scenario prompt provided by the provider to the customer across the link; wherein the scenario prompt includes an emergency or non-emergency scenario to generate a series of responses by the customer which are provided back to the provider across the link; and a summary having at least one of an activity, article/periodical, and/or product to recommend a solution to a vulnerability identified by the provider based, at least in part, on the completion of the scenario prompt that may include the means, relationships and/or industry know-how to perform the follow-on activities. This exemplary embodiment or another exemplary embodiment may further provide a first activity that recommends solutions to the scenario prompt in response to the series of responses sent across the link. This exemplary embodiment or another exemplary embodiment may further provide wherein the first activity teaches the customer to perform actions quick in response to the identified vulnerability. This exemplary embodiment or another exemplary embodiment may further provide wherein the first activity teaches employees of the customer to leave their belongings behind in the event of an emergency. This exemplary embodiment or another exemplary embodiment may further provide a recommendation for a product that reduces the likelihood of damage from the identified vulnerability. This exemplary embodiment or another exemplary embodiment may further provide reading materials for the customer to read on topics pertaining to the identified vulnerability. This exemplary embodiment or another exemplary embodiment may further provide an activity to be performed by persons associated with the customer subsequent the scenario prompt operative to further teach the persons associated with the customer to take appropriate actions in response an event in which the identified vulnerability actually occurs. This exemplary embodiment or another exemplary embodiment may further provide an implementation plan to including steps for the customer to implement recommendations from the provider in the summary, wherein the implementation plan is generated in response to the series of responses by the customer. This exemplary embodiment or another exemplary embodiment may further provide wherein the provider generates the implementation plan through an analysis of capabilities taken from predefined goals and evaluation of participant responses from the role-playing scenario and details the participant response relative to the predetermined goal; and wherein the analysis of capabilities details observations recorded by the participants during the role-playing scenario relevant to core capabilities and the core capabilities may be selected from a group comprising planning, situational assessment, risk and disaster resilience, and public information and warning. This exemplary embodiment or another exemplary embodiment may further provide planning capabilities configured to conduct a systematic process engaging the customer as appropriate in the development of executable strategic, operational, or tactical level approaches to meet defined objectives. This exemplary embodiment or another exemplary embodiment may further provide a first set of objectives in the implementation plan; a second set of objects in the implementation plan; wherein the first set of objects recognize vulnerabilities at a location determined by the customer; wherein the first set of objectives have an associated core capability of situational awareness and planning. This exemplary embodiment or another exemplary embodiment may further provide a first subset of the first set of objectives, wherein the first subset is an organization and leadership subset; and a second subset of the first set of objectives, wherein the second subset is a planning and personnel subset. This exemplary embodiment or another exemplary embodiment may further provide at least one recommendation provided by the provider to the customer within the implementation plan for issues and areas for improvement associated with the first subset and second subset. This exemplary embodiment or another exemplary embodiment may further provide a list of necessities provided by the provider to the customer to make the location less vulnerable to the identified vulnerability. This exemplary embodiment or another exemplary embodiment may further provide a third set of objectives in the implementation plan. This exemplary embodiment or another exemplary embodiment may further provide a business impact analysis provided to the customer by the provider in response to completion of the scenario prompt that effectuates the customer to implement the implementation plan. This exemplary embodiment or another exemplary embodiment may further provide goals added to the implementation plan by the customer to be completed within a specific timeframe. This exemplary embodiment or another exemplary embodiment may further provide wherein the implementation plans includes recommendations populated from customer responses to the scenario prompt. This exemplary embodiment or another exemplary embodiment may further provide a table comprising cells to be populated by the customer in accordance with a predetermined legend or key, wherein the table is adapted for the customer to use the key to evaluate whether the recommendations are appropriately described and evaluated. This exemplary embodiment or another exemplary embodiment may further provide wherein at least one cell of the table is associated with an existing rating that the customer perceived as the recommendation, and wherein the table further includes: at least one cell relating to a project rating for when customer completes implementing the recommendation.

In yet another aspect, an exemplary embodiment of the present disclosure may provide a method for identifying emergency or non-emergency vulnerabilities comprising: providing a role-playing scenario to a customer across a link for the customer to execute; receiving data responses generated by the customer in response to execution of the role-playing scenario; analyzing the data response for vulnerabilities that the customer identified during execution of the role-playing scenario and summarizing the data response in a summary; and providing in the summary, to the customer across the link, an action call recommendation that includes one of a product to purchase, a periodical to read, a video to watch, and an activity to perform adapted to mitigate or remediate one or more of the emergency or non-emergency vulnerabilities. This exemplary embodiment or another exemplary embodiment may further provide accumulating responses from the customer across the link until a sufficient amount of responses has been accumulated to generate the action call recommendation. This exemplary embodiment or another exemplary embodiment may further provide blocking and removing outlier responses provided during the execution of the role-playing scenario. This exemplary embodiment or another exemplary embodiment may further provide commanding a customer to improve a physical or virtual facility subsequent to execution of the role-playing scenario. This exemplary embodiment or another exemplary embodiment may further provide compressing, digitally, the summary prior to sending the summary to the customer across the link. This exemplary embodiment or another exemplary embodiment may further provide customizing the summary for addressing the emergency and non-emergency vulnerabilities in response to the data responses generated during the role-playing scenario. This exemplary embodiment or another exemplary embodiment may further provide deriving the action call recommendations from a database of available action call recommendations stored in at least one non-transitory computer readable storage medium located remotely from a physical or virtual facility of the customer; and differentiating one action call recommendations from another action call recommendation in the summary; displaying the differentiated action call recommendations in the summary; embedding links in the summary to wireless link connect the customer with an item associated with one response action call recommendation; and distributing the summary over the link. This exemplary embodiment or another exemplary embodiment may further provide altering, dynamically, the summary in response to receiving multiple sets of data response from the customer provided across the link. This exemplary embodiment or another exemplary embodiment may further provide financing a portion of the summary with advertising revenue from a third party associated with at least one products recommended to the customer in one of the action call recommendations provided across the link. This exemplary embodiment or another exemplary embodiment may further provide pre-determining, prior to generating the summary, a set of action call recommendations that will be recommended in the summary based on the role-playing scenario executed by the customer. This exemplary embodiment or another exemplary embodiment may further provide rating, in the summary, an effectiveness of the action call recommendations for the customer based on a rating system independent from the customer.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a diagrammatic view of a provider and a customer connected via a link and an item, either real or electronic, traveling along the link.

FIG. 2 is a flow chart of an exemplary method of identifying a vulnerability and providing recommendations responsive to the vulnerabilities.

FIG. 3 is a flow chart of a method of generating an after action report in accordance with the method of FIG. 2.

FIG. 4 is an exemplary first page of a facilitator's guide for leading a role-playing game or scenario to identify vulnerabilities.

FIG. 5 is an exemplary second page of the facilitator's guide for leading the role-playing game or scenario to identify vulnerabilities.

FIG. 5A is an exemplary first page from a workbook provided to participants by the facilitator.

FIG. 5B is an exemplary first page from the workbook provided to participants by the facilitator.

FIG. 6 is an exemplary third page of the facilitator's guide for leading the role-playing game or scenario to identify vulnerabilities.

FIG. 6A is an exemplary third page from the workbook provided to participants by the facilitator.

FIG. 6B is an exemplary fourth page from the workbook provided to participants by the facilitator.

FIG. 7 is an exemplary fourth page of the facilitator's guide for leading the role-playing game or scenario to identify vulnerabilities.

FIG. 7A is an exemplary fifth page from the workbook provided to participants by the facilitator.

FIG. 7B is an exemplary sixth page from the workbook provided to participants by the facilitator.

FIG. 7C is an exemplary seventh page from the workbook provided to participants by the facilitator.

FIG. 8 is an exemplary fifth page of the facilitator's guide for leading the role-playing game or scenario to identify vulnerabilities.

FIG. 8A is an exemplary eighth page from the workbook provided to participants by the facilitator.

FIG. 9 is an exemplary short form summary of the events of the role-playing game or scenario to identify vulnerabilities.

FIG. 10 is a second page of the exemplary short form summary of the events of the role-playing game or scenario to identify vulnerabilities, particularly providing recommendations which may include activities or products to alleviate or obviate the identified vulnerabilities.

FIG. 10A is another example of a second page of the short form summary of the events of the role-playing game or scenario to identify vulnerabilities, particularly providing recommendations including products to purchase, articles to read, videos to watch, and actions or activities to alleviate or obviate the identified vulnerabilities.

FIG. 11 is an exemplary overview for a long form summary.

FIG. 12 is an exemplary first page of the long form detailed summary identifying strengths, vulnerabilities, and recommendations.

FIG. 13A and FIG. 13B are an exemplary analysis of capabilities from the detailed or long form summary.

FIG. 14A and FIG. 14B are an exemplary improvement plan from the detailed or long form summary.

FIG. 15A and FIG. 15B are an exemplary impact analysis from the detailed or long form summary.

FIG. 16 depicts an exemplary first page from a workbook in accordance with a second embodiment of the present disclosure associated with a non-emergency scenario.

FIG. 17 depicts an exemplary second page from the workbook in accordance with the second embodiment of the present disclosure associated with a non-emergency scenario.

FIG. 18 depicts an exemplary third page from the workbook in accordance with the second embodiment of the present disclosure associated with a non-emergency scenario.

FIG. 19 depicts an exemplary fourth page from the workbook in accordance with the second embodiment of the present disclosure associated with a non-emergency scenario.

FIG. 20 depicts an exemplary fifth page from the workbook in accordance with the second embodiment of the present disclosure associated with a non-emergency scenario.

FIG. 21 depicts an exemplary sixth page from the workbook in accordance with the second embodiment of the present disclosure associated with a non-emergency scenario.

FIG. 22 depicts an exemplary seventh page from the workbook in accordance with the second embodiment of the present disclosure associated with a non-emergency scenario.

FIG. 23 depicts an exemplary eighth page from the workbook in accordance with the second embodiment of the present disclosure associated with a non-emergency scenario.

Similar numbers refer to similar parts throughout the drawings.

### DETAILED DESCRIPTION

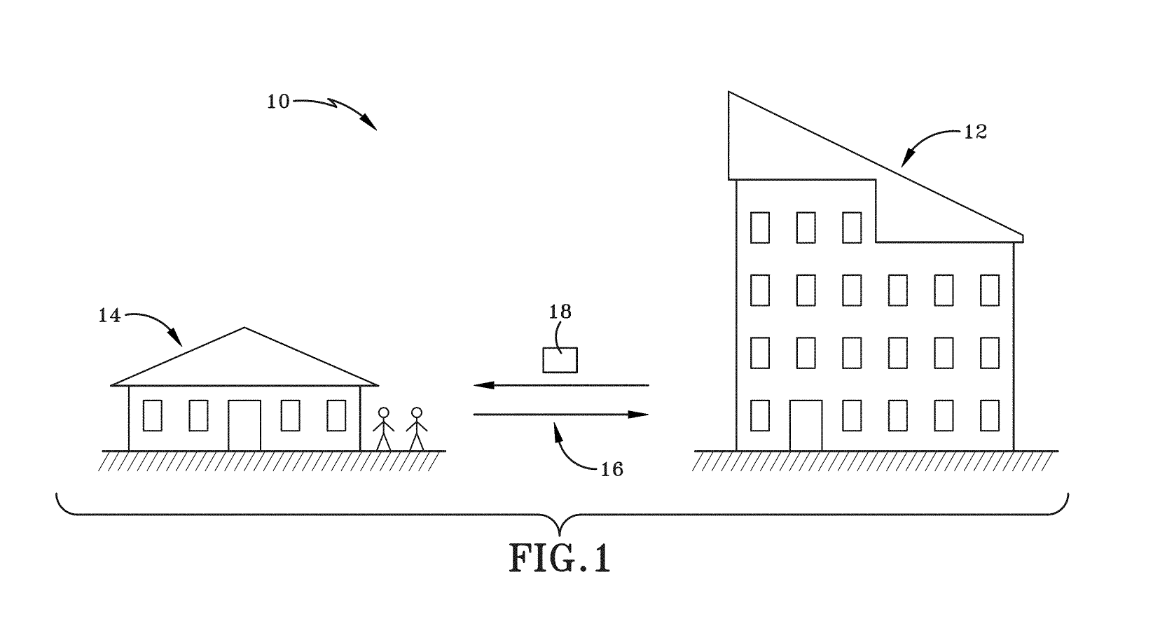

FIG. 1 depicts a diagrammatic view of a system for identifying a vulnerability or weakness and recommendations to correct the same generally at 10. In a broad aspect, system 10 includes a provider 12, which may also be referred to as a supplier, and a customer 14. The provider 12 and the customer 14 are operatively connected to each other via link 16. Link 16 represents a communication link between the provider 12 and the customer 14. In one non-limiting example, the link 16 may be a non-physical association establishing a working relationship between the provider 12 and the customer 14. The provider 12 may supply contents 18, such as a package of information, along the link 16. In some exemplary embodiments, the package 18 is delivered via regular U.S. mail or carrier, and in other embodiments, the package 18 may be delivered through an electronic communication link, such as email or another similar electronic link, such as file transfer protocol (FTP) or a common account, such as a drop box. Once the association between the provider 12 and the customer 14 is established, an exemplary method in accordance with the present disclosure may be implemented.

The term “provider” refers to a person or company/organization that desires to provide services to a customer 14 in order to identify vulnerabilities of the customer 14. In one exemplary aspect, the supplier 14 may be company that supplies services to customers via in-person demonstration, web-conferencing demonstrations, or mail-order delivery of products and instructions. One non-limiting and exemplary supplier 14 is Critical Ops, LLC of Ohio.

The term “customer” refers to any person, group of people, organization, or entity that desires to have its vulnerabilities identified and receive recommendations as to how to improve the same. In some exemplary aspects, the customer 14 will be an organization, such as a faith-based organization or a business, having a physical location inside a building or structure. In one particular embodiment, the vulnerabilities relate to the physical threats that the organization based on their presence in the structure. In other embodiments, the threats may be non-physical or unrelated to the location. For example, a congregation housed with a church may be vulnerable to a potential active shooter who disagrees with the congregant's beliefs. However, it is entirely possible for the customer to be an organization that operates in a virtual manner without a physical structure. For example, a virtual organization that operates substantially online may still benefit from system 10 due to its vulnerability to digital threats, such as computer viruses or hackers. Threats could also be identified and addressed as they relate to culture, inclusion and/or other non-life threatening related threats stemming from a potentially adverse relationship between two or more parties or groups or within perceptions, biases and assumptions that are impacting an organization or in the capacity as the vulnerabilities that affect the growth or reputation of the organization.

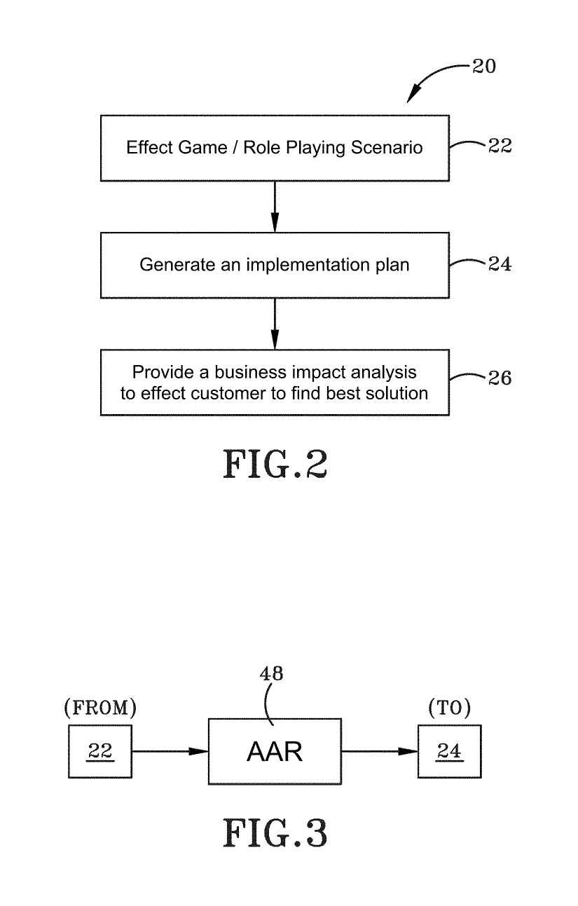

FIG. 2 depicts an exemplary flowchart in accordance with an exemplary method of the present disclosure generally at 20. Method 20 includes effecting the playing or execution of a game or role-playing scenario, which is shown generally at 22. In one implementation, the effecting the game or role-playing scenario is accomplished by the provider 12, as it is the customer that actually conducts the scenario. Method 20 further includes generating an implementation plan in response to the completion of the role-playing game or scenario, which is shown generally at 24. The implementation plan may be generated by the provider 12 after the scenario or game play has concluded and the results are sent from the customer 14 to the provider 12, typically along link 16. Method 20 further includes providing a business impact plan, or more generally a summary, from the provider 12 to the customer 14. The summary may include an analysis of the implementation plan and effecting the customer to implement a solution to the liabilities and vulnerabilities that have been discovered by the customer 14 after completing the scenario, which is shown generally at 26.

System 10 is configured to identify weaknesses and vulnerabilities of the customer 14. The weaknesses and vulnerabilities can be physical vulnerabilities or they can be nonphysical vulnerabilities (i.e., such as digital vulnerabilities and interpersonal vulnerabilities). For example, system 10 can identify a weakness in a facility of a customer 14 in an emergency situation. More particularly, a variety of emergency situations or scenarios may be provided by the provider 12 through a role-playing scenario which is configured to identify the vulnerabilities or weaknesses in order to provide the customer 14 with suggestions to improve their facility or other nonphysical elements. While the system 10 is exemplified herein as an emergency management identification system, it is to be understood that the concepts and execution strategies provided herein may be broadly applied to any scope of a customer's business. For example, the scenarios provided by system 10 configured to identify vulnerabilities need not be emergent in nature. They may be non-emergency scenarios that can identifies vulnerabilities or weaknesses in the organization, such as HR personnel issues. For example, system 10 can be expanded to address instances of workplace inclusiveness and diversity. One exemplary non-emergency situation may provide a role-playing scenario to identify an organization's vulnerabilities in addressing instances of sexual harassment, or the like, in the work place. Another exemplary non-emergency situation may provide a role-playing scenario to identify an organization's vulnerabilities in addressing instances of emerging growth opportunities or reputation management, or the like, external to the work place.

When the system 10 is executed or implemented as an emergency preparedness consultant, the provider 12 may identify how the customer 14 should respond to that given emergency based on a variety of vulnerabilities identified as a result of the completed scenario or role play. By way of non-limiting example, some emergency scenarios of system 10 utilizes in its role-playing scenario may include an active shooter situation, or natural disasters, or other man made emergencies or hybrids thereof. For a variety of natural disasters, some exemplary emergency scenarios may include: (1) inclement weather, at any time of week “Weekday, weekend, start of holiday weekend, end of holiday weekend, dawn, morning rush hour, daytime, afternoon, evening rush hour, dusk, and nighttime”; (2) Natural Disaster—Weather—All Side Effects—Power outages, structural collapse, avalanche, landslide, disease outbreak, thunder/lightning, lake effect, nor'easters, whiteout conditions, traffic accidents, liquefaction, tsunami, volcanic activities, riots; (3) Natural Disaster—Weather—All Conditions—surrounding weather related disasters, Light snow, white out, sunny, overcast, light rain, heavy rain, torrential rain, fog, solar glare (dawn or dusk), extreme wind, freezing rain, drought, heat waves, cyclical climate changes, regional weather patterns, daytime hours, increased temperatures, wind speeds, civil unrest; (4) Natural Disaster—Weather Hurricane Categories by wind speed—“Cat 1: 74-95 mph wind, Cat 2: 96-110 mph wind, Cat3: 111-129 mph wind, Cat4: 130-156 mph wind, Cat5: 157 mph or higher wind”; (4) Natural Disaster—Weather Hurricane Dates by naming “North Atlantic: June 1-November 30, Eastern Pacific: May 15-November 30”; (5) Natural Disaster—Weather—Tornado Fujita Scale “F0: 73 mph wind or less, F1: 74-112 mph wind, F2: 113-157 mph wind, F3: 158-206 mph wind, F4: 207-260 mph wind, F5: 261 mph or higher wind”; (6) Natural Disaster—Weather—Heat Wave Region—“North: 90° F. or hotter, South: 100° F. or hotter”; (7) Natural Disaster—Weather—Winter Storm; (8) Natural Disaster—Weather—Earthquake—Richter Magnitude Scale “Less than 2.0: Minor; not felt and continual, 3.0-3.9: Minor; felt but no damage with 130,000 per year, 4.0-4.9: Light; noticeable shaking but no damage with 13,000 per year, 5.0-5.9: Moderate; major damage to poorly designed buildings and slight damage, 6.0-6.9: Strong, destructive, 134 per year, 7.0-7.9: Major with serious damage over large areas, 15 per year, 8.0-8.9: Great; serious damage over hinders of kilometers, 1 per year, 9.0-9.9: Great; devastating damage over thousands of kilometers, 1 per 10 years, 10.0+: Massive; damage across large area, never recorded”; (9) Natural Disaster—Weather—Wildfire/Fire Causes—Lightning, spontaneous combustion, arson, discarded cigarettes, power-line arcs, and campfires; (10) Natural Disaster—Weather—Flood Causes—Rainfall, snow melting, hurricane/coastal storm, storm surge, tsunami, dam/dike/levee breach; (11) Natural Disaster—Biological—Disease Outbreak Causes—Infected food/drinking water or seasonal/weather; (12) Natural Disaster—Biological—Disease Outbreak—Transmission “Airborne, Zoonotic (animal to person), Biological (person to person), and Generational/genetic.

Other exemplary emergencies may be manmade, which may include (1) Manmade—Civil Unrest—Shooting Causes—Terrorism, workplace violence, domestic violence, school violence, gang related, police related, accidental, and self-defense; (2) Manmade—Civil Unrest—Mass Gathering Causes—Protest, concert, sporting event, state/county fair, parade, unforeseen event; (3) Manmade—Terrorism—Chemical—Types Blood, blister, nerve, pulmonary; (4) Manmade—Terrorism—Chemical—Method of Distribution “Aircraft, boat, vehicle, aerosol canister, explosives”; (5) Manmade—Terrorism—Biological—Types—Bacterial, viral, toxins; (6) Manmade Terrorism Biological Category “A: High morality, major public health impact, B: Low mortality, easy to eliminate, C: Engineered for mass dissemination, easily produced, high mortality rate, major public health impact”; (7) Manmade—Terrorism—Biological—Method of Distribution—Aircraft, boat, vehicle, aerosol canister, explosives, mail, and spray bottle; (8) Manmade—Terrorism—Radiological Type of Contamination—Internal or External; (9) Manmade—Terrorism—Radiological—From Dust or liquid; (10) Manmade—Terrorism—Radiological Transmission—“Inhaled, Injected, Through breaks on the skin”; (11) Manmade—Terrorism—Nuclear—Acquisition of Materials to Build Purchase through black market, purchase through nation-state, illegally built by nuclear scientists, theft from military base, plane, or submarine, or theft from nuclear reactor; (12) Manmade—Terrorism—Explosion—Type IED, VBIED, PBIED, Military arms; (13) Manmade—Terrorism—Explosion—Acquisition Illegally built or stolen from military instillation; (14) Manmade—Terrorism—Explosion—Concealment Backpacks, trash, vehicle, under clothing; (15) Manmade—Technological—Cyber Types—“Viruses: Self-replicating program that can reproduce corrupt files, Worms: Self-sustaining program. Industrial espionage to collect server and traffic activities back to its creator Trojan horses: Masked as a known platform. Usually houses and infects computer with many viruses and worms”; (16) Manmade—Technological—Cyber Contracted—Email, browsers, chat rooms, remote software, updates; (17) Manmade—Technological—Power Outage Causes—Cyber-attack, short circuit, terrorism, accidental damage to power lines, substations, or distribution systems; (18) Manmade—Accidental—Transportation—Location of Accident—Rural road, urban road, state highway, highway on/off ramp, bridge, tunnel, parking lot/garage; (19) Manmade—Accidental—Transportation Causes—Drunk/impaired driver, distracted driver, road rage, weather conditions, unsecured debris, transportation medium safety, failing natural debris (tree, rock, etc.).

Other emergency scenarios within the scope of System 10 include components that include both a manmade aspect and a natural aspect. For example, some emergency scenarios encompassed by system 10 include environmental emergencies, such as animal extinctions, and environment Damage Assessment including life (victims, casualties, fatalities), heath (e.g. common injuries, victims, casualties, fatalities), hard resources (e.g. infrastructure, homes, vehicles, finances), soft resources (e.g. leaking of sensitive information, identity theft), loss of control systems (e.g. telecommunication, water, transportation), crime (fires, oil spills, chemical accidents, toxic-waste dumping), riots.

Again, there are many non-emergency scenarios that could be presented as part of the role-playing scenario that could identify vulnerabilities relating to (1) sexual harassment issues in the organization, (2) workplace safety, (3) age related issues in the organization, (4) hazardous environments in the organization, (5) accounting issues in the workplace, (6) theft in the workplace, (7) wage issues in the workplace and required state minimum wages, (8) dress code and grooming issues in the workplace, (9) religious discrimination in the workplace, (10) gender or gender-identity discrimination in the workplace, (11) racial discrimination in the workplace, (12) alcohol/drug-use or alcohol/drug abuse by employees or members of the organization; however, other scenarios are entirely possible, or (13) business development objectives, such as client retention, reputation management, and new business development.

FIG. 3 depicts that an after action report (AAR) may be generated subsequent to the game or role-playing scenario performed by the customer 14. The customer sends the results of the game or scenario to provider 12, typically in a return package 18 across link 16. Stated otherwise, provider 12 affects the role-playing scenario 22, which is executed by the customer 14, and a plurality of results are obtained and sent to the provider 12 over link 16. Once the provider 12 receives the results, the provider may review and create an AAR 48. The AAR 48 may be used to generate the implementation plan, which is shown generally at 24. While the AAR 48 is depicted as occurring prior to the generation to the implementation plan, they may be created or generated simultaneously.

In one particular embodiment, the game or role-playing scenario is a customized scenario configured to build community and teamwork driven by a framework of specific considerations, depending on the type of customer executing the program. The role-playing scenario typically includes visual summarizes and recommended products, actions/games, or periodicals/articles to review subsequent to completion of the program. In one particular embodiment, the role-playing scenario or program may be a one-hour experience that creates an informal meeting for participants to discuss a potential emergency. Facilitators may be provided by the provider 12 for peers and participants of the program in scenarios to openly exchange ideas and needs while gaining a better understanding of roles and responsibilities before, during, and after an emergency. Some participants may be split into various teams such that different teammates will identify strengths, areas of improvement, and actionable steps to help identify the vulnerabilities for the customer 14. It is envisioned that the role-playing scenario may be implemented by faith-based organizations, educational organizations, caregiving organizations, community organizations, business associations, health organizations, safety and emergency professionals, general business organization, and other not-for-profit and for-profit entities and others alike. This system would additionally be operative with a collection of individuals not otherwise organized within an overarching organization. For example, a group of job seekers would benefit from this system 10 to demonstrate capability to future employers or as a professional development series.

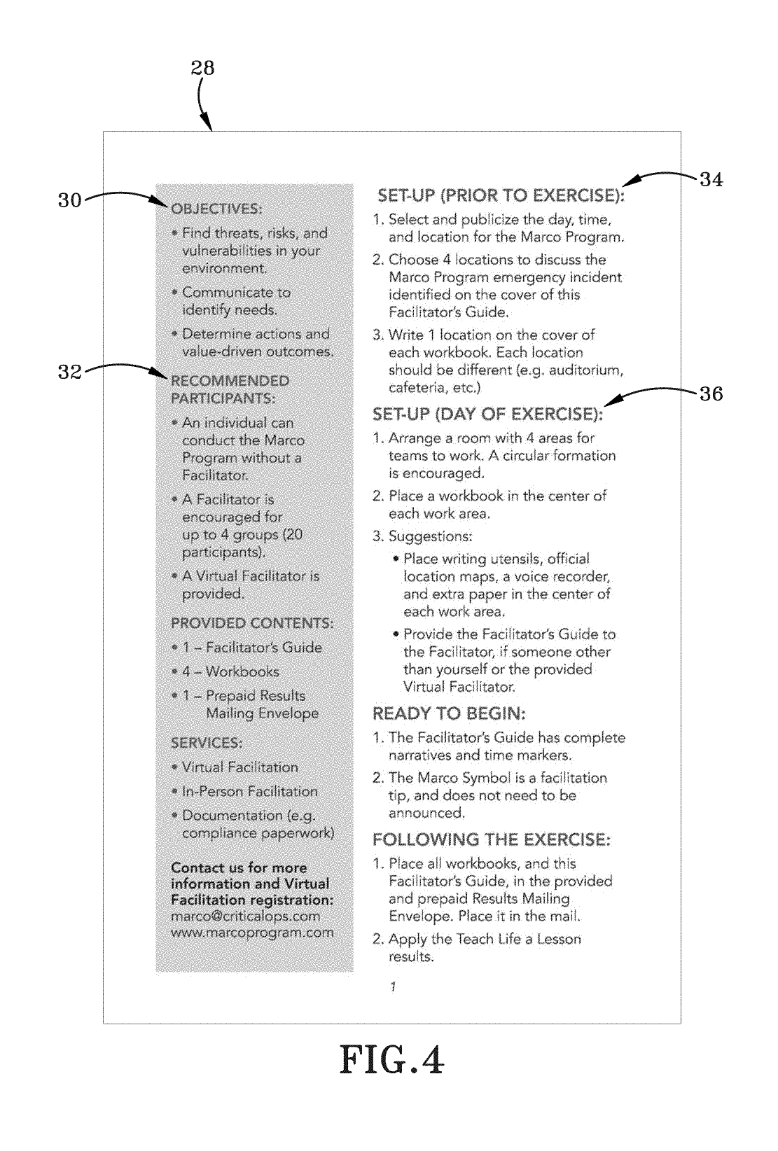

FIG. 4 depicts an exemplary first page from a facilitators guide 28 provided by the provider company 12 to the customer 14 across link 16. The role-playing scenario or framework of the program provides objectives 30, which are configured to find the threats, risks, and vulnerabilities in an environment and to communicate and to identify various needs, and to determine actions and value-driven outcomes. The recommended participants 32 of the program of the customer 14 is a group of about twenty participants that may be split into four groups of five, however other divisions and sizes are entirely possible. An individual facilitator can lead the program and, additionally, a virtual facilitator may be provided. The virtual facilitator may be in communication with the customer 14 through a remote link, which may be the same link as link 16. However, it is to be understood that the virtual facilitator may be at a location separate and distinct from the provider 12. The role-playing scenario provides for a facilitator to set up 34 prior to the program. The setup prior to the exercise includes selecting and publicizing the day, time, and location for the role-playing scenario. Then, prior to the exercise, the facilitator typically chooses at least four locations to discuss the program and incident identified by the program; however fewer or more locations are entirely possible. The facilitator may scribe or write one location on the cover of a workbook provided to each group of participants. Each location should be different relative to the respective groups. After the initial setup at 34, the facilitator may setup on the day 36 of the program or exercise. During the setup 36, the facilitator may arrange the room with four areas (or more areas or fewer areas) for teams to work. Typically, a circular formation of the chairs for the teams is encouraged when meeting in the physical space. The facilitator should place a workbook in the center of each work area. The facilitator may also provide writing utensils, official locations on maps, a voice recorder, and extra paper in the center of the work area. The facilitator's guide may be provided to another person if a second facilitator is leading the exercise. The facilitator and participants in the exercise should follow the queues provided in the facilitator guide and record the result as they are populated. Once the results are populated, the results may be input into a mailing envelope and sent from the customer 14 to the provider 12 across link 16. In one non-limiting example, a mail or other registered carrier may supply the contents and results from the exercise from the customer 14 to the provider 12. In other scenarios, the facilitator may email (or conduct any other form of electronic transfer) the results to the provider company 12.

While the aforementioned discussion pertains to the physical space and some exemplary layouts thereof, it is possible for the program to be conducted in a completely or at least partially on-line or remote manner. In this instance, the facilitator guide could split participants into groups that are remotely arranged via computer networks or other VPNs/LANs. In these instances, the groups can be formed by facilitator or may be randomly assigned by the operator of the system or its random group generator.

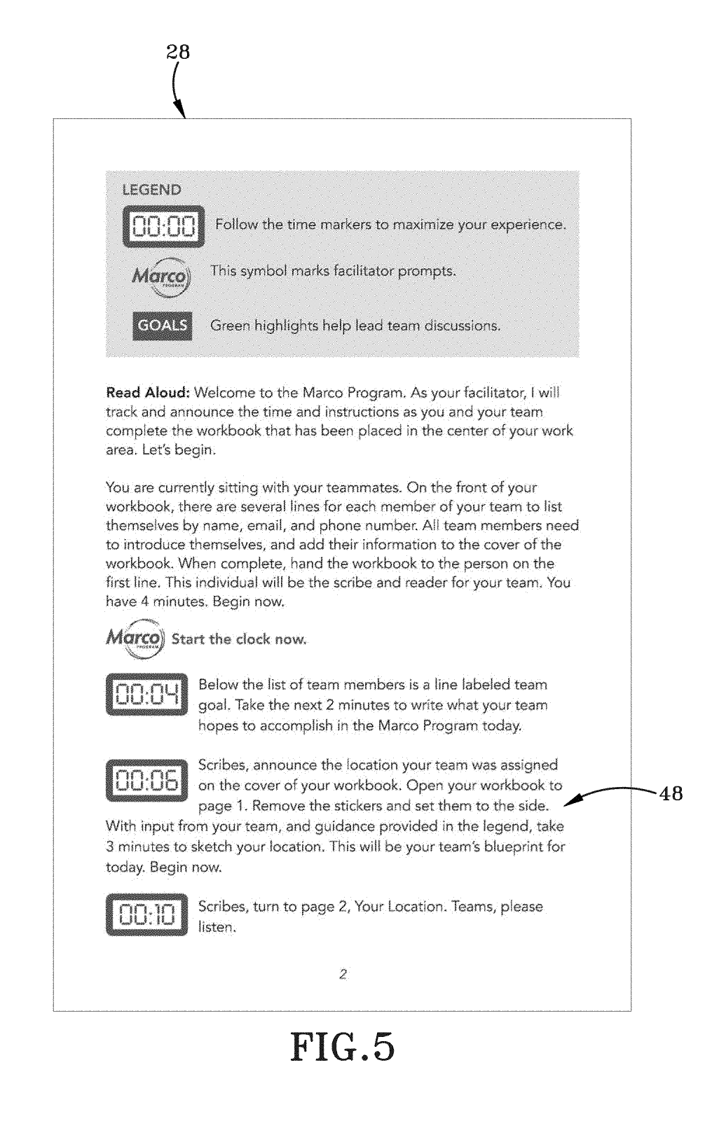

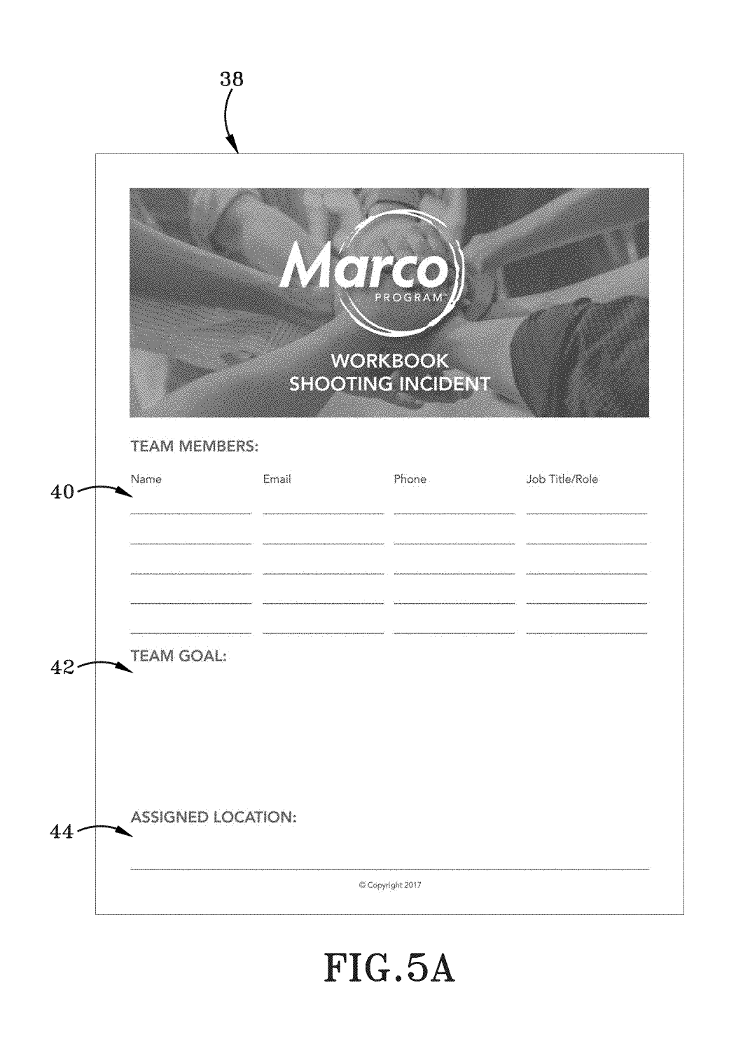

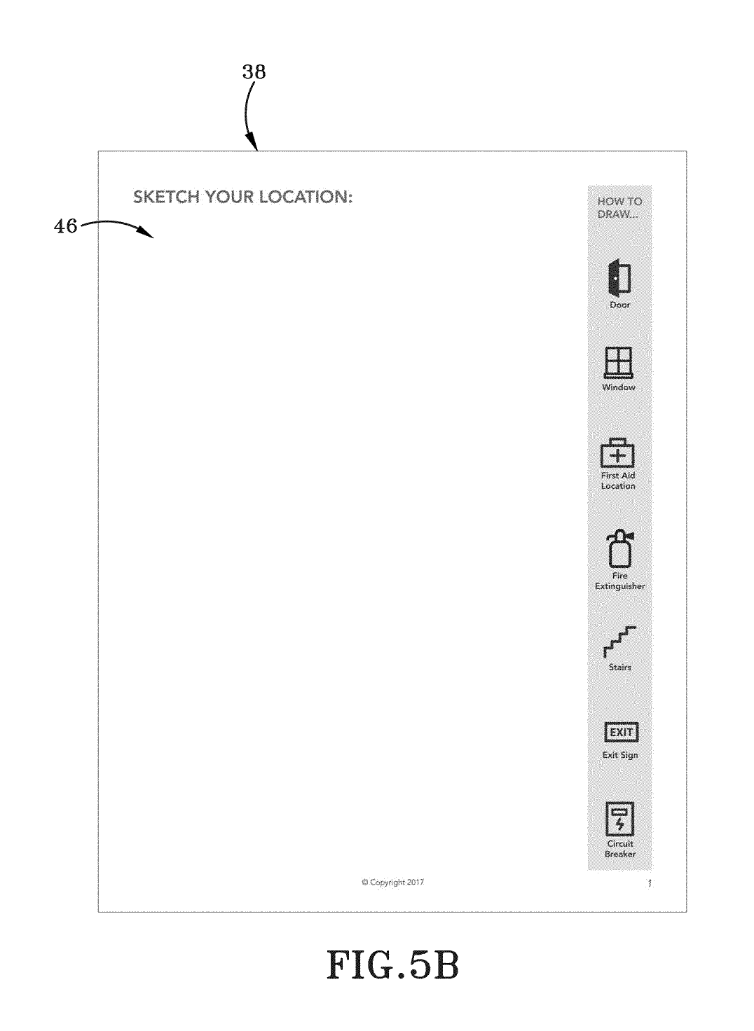

FIG. 5 represents an exemplary second page of the facilitator's guide 28. The facilitator's guide 28 begins with encouraging the participants to sit with their respective teammates. On the front of a separate workbook 38 (FIG. 5A), there may be provided several lines 40 for each team member to list themselves by name, email, and phone number. The team member should introduce themselves and add their information to the cover of the workbook 38. When the workbook 38 is complete, it is provided to the person on the first line to act as a scribe for the exercise. Each team is provided a different team goal 42 (FIG. 5A), or identifies their team goal, and location 44 (FIG. 5A) by the facilitator. The teams will read their location and begin to sketch their respective location 46, which is shown generally at 48. Notably, while the workbook 38 depicted in FIG. 5A and FIG. 5B may be presented or provided in digital format or a hard copy. Further, the location can be a place or location of the participants at the time the program is led by facilitator, or it may also be considered to be a fictitious place either a realistic physical setting or a virtual frame of mind as it may treated to a real or depicted customer or idea. (e.g., current storage room, proposed storage room design, manifestation of what a cultural diverse network of work relationships may look like, etc.).

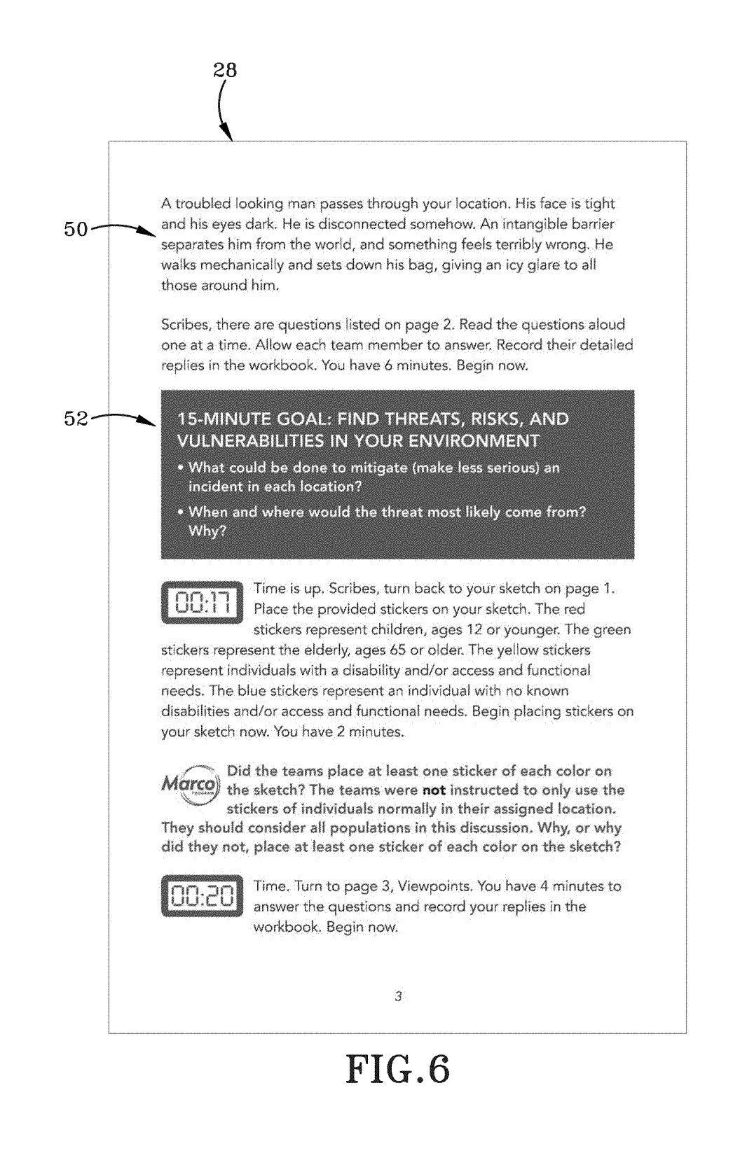

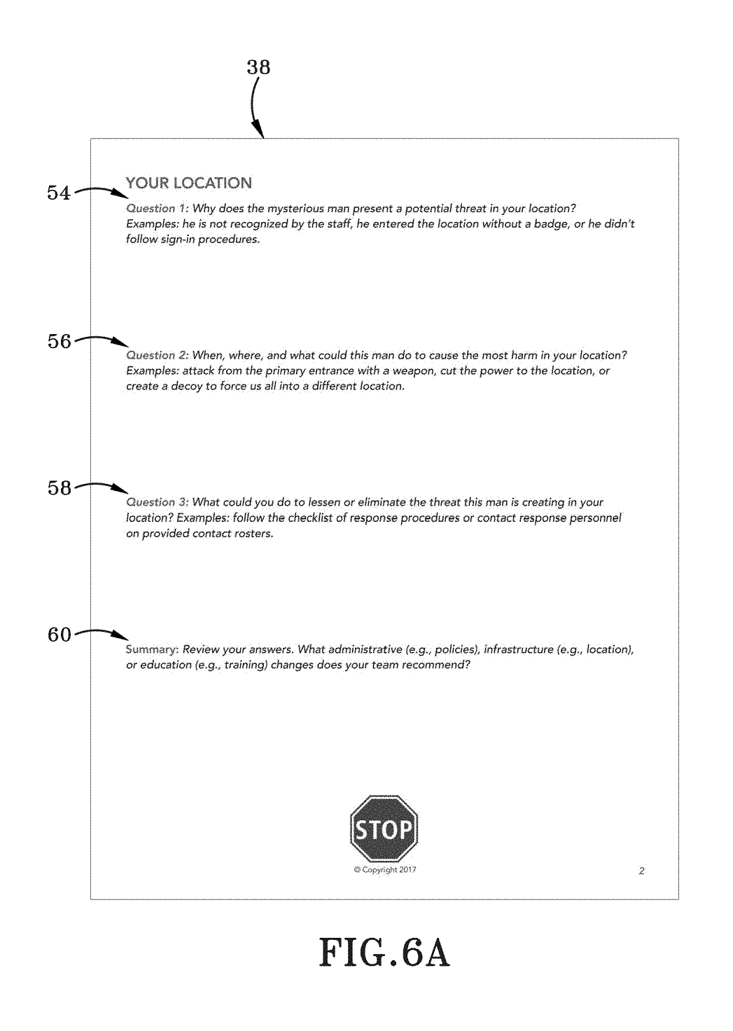

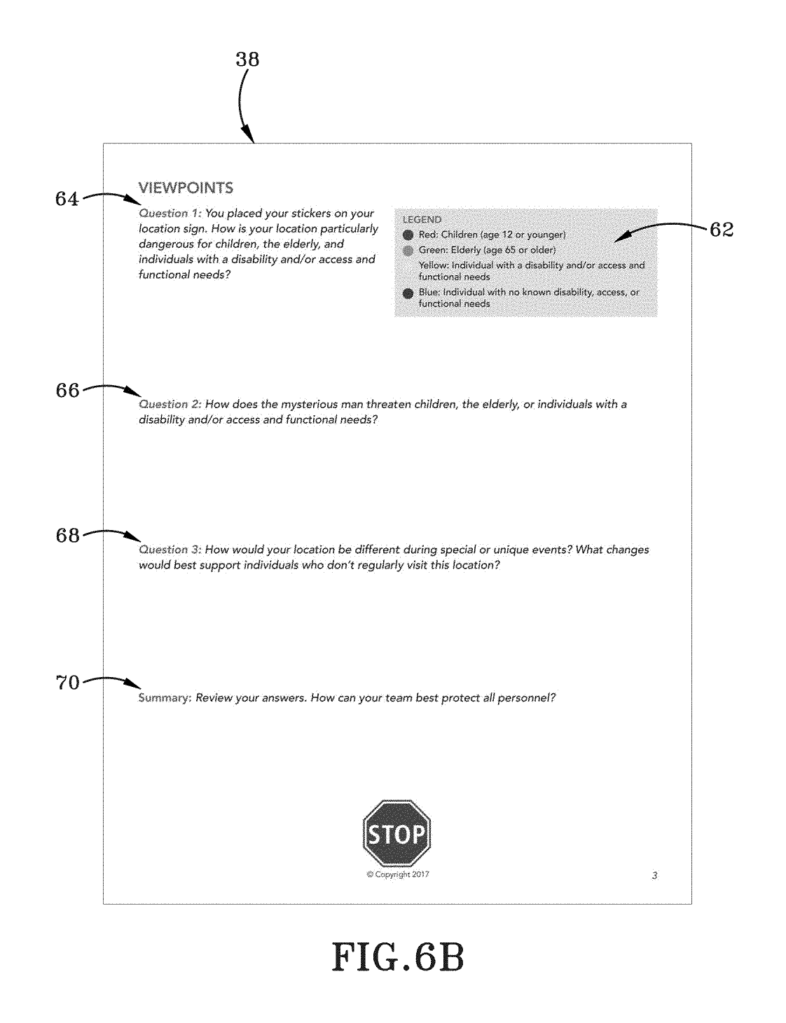

FIG. 6 depicts an exemplary third page of the facilitator guide 28. During the program, the facilitator instructs the team to read a prompt, which is shown generally at 50, that may relate to an initial scenario, which may or may not be an emergency. After reading the prompt 50, the teams are given an initial period in order to find threats, risks, and vulnerabilities in their environment, which is shown generally at 52. In one particular embodiment a prompt 50 states: “A troubled looking man passes through your location. His face is tight and his eyes dark. He is disconnected somehow. An intangible barrier separates him from the world and something feels terribly wrong. He walks mechanically and sets down his bag, giving an icy glare to all around him. The participants then find threats, risks, and vulnerabilities, shown generally at 52, by answering questions or prompts, such as “what could be done to mitigate (make less serious) an incident in each location?” or “when and where would the threat most likely come from? Why?”

FIG. 6A is an exemplary page from workbook 38 associated with the facilitator guide 28 prompts from FIG. 6. For example, the workbook 38 may include at least one prompt 54 associated with a mysterious person present in your location and whether the mysterious person poses a potential threat. There may also be a second prompt 56 and a third prompt 58. The second and third prompts 56, 58 in the workbook 38 require the participants to answer “when, where, and what” this mysterious person could do to harm the participant's location, and what the participant could do to eliminate or lessen the threat. The workbook 38 also may provide a summary section 60 for the participants to develop recommendations based on their answers to the prompts 54, 56, 58. Notably, while these prompts have been tailored to an active shooter scenario, it is understood that the prompts will be re-written to identify vulnerabilities for any of the other emergency and non-emergency scenarios presented above.

With continued reference to FIG. 6, the program then can require participants to place a variety of stickers (or other mechanisms, real or virtual, to identify areas either physically or in a virtual or augmented reality setting) onto a page representing their location. The sticker or other identifiers may be associated with persons in that location, or concepts that identify frame-of mind, and/or other means to provide various reference points used based upon the overarching concept of the program being administered. For example, a red sticker can represent children, ages 12 or younger. A green sticker can represent the elderly, ages 65 or older. Yellow stickers can represent individuals with a disability and/or access and function needs. Blue stickers can represent able-bodied individuals.

FIG. 6B is an exemplary page from workbook 38 associated with the prompts from FIG. 6. Within the notebook 38, the participants may place a variety of stickers 62 representing persons based on age or abilities or needs. This page may include at least one prompt 64 asking the participants whether the stickers 62 are properly placed and how dangerous the location is based on the persons represented therein. Second and third prompts 66, 68 then require participants to address how specifically the emergency scenario will apply to those persons. For example, in an active shooter scenario, as indicated by second prompt 66, will the mysterious man have access to certain person. Additionally, as indicated by the third prompt 68, how would the location be different during exceptionally busy or special events? This page of the workbook 38 may also include a summary 70 or review to enable participants to identify how their team can best protect all personnel.

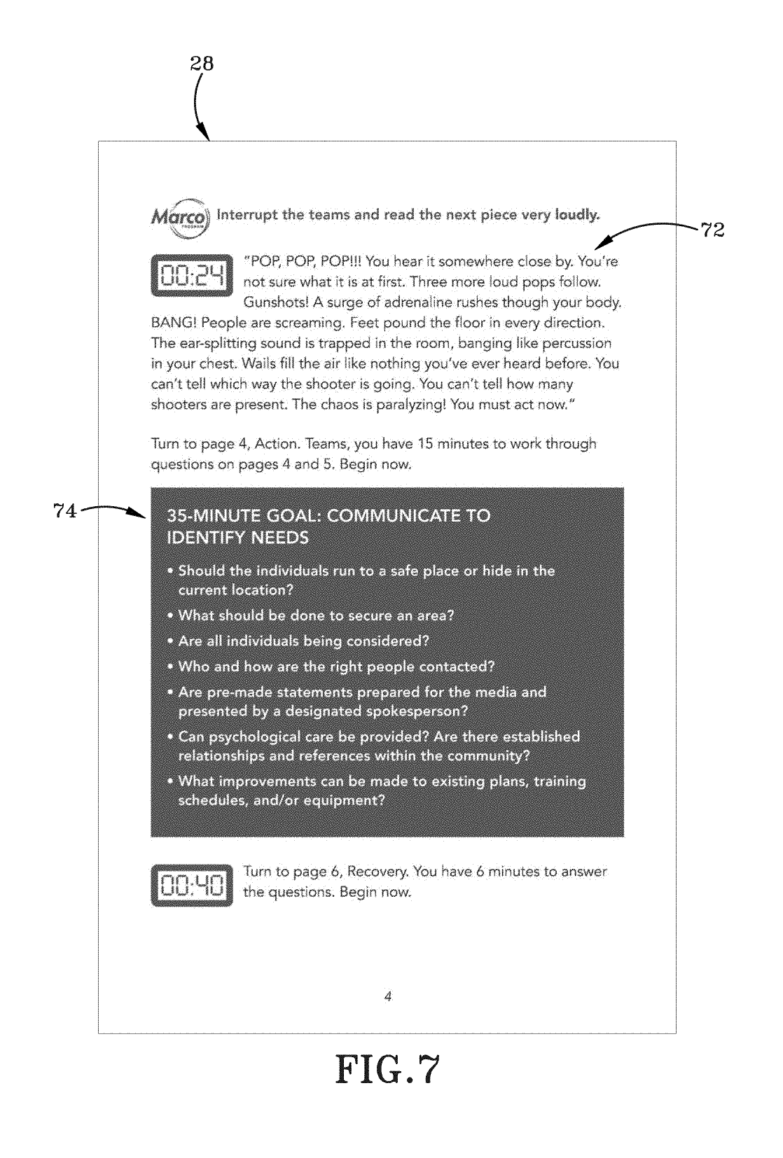

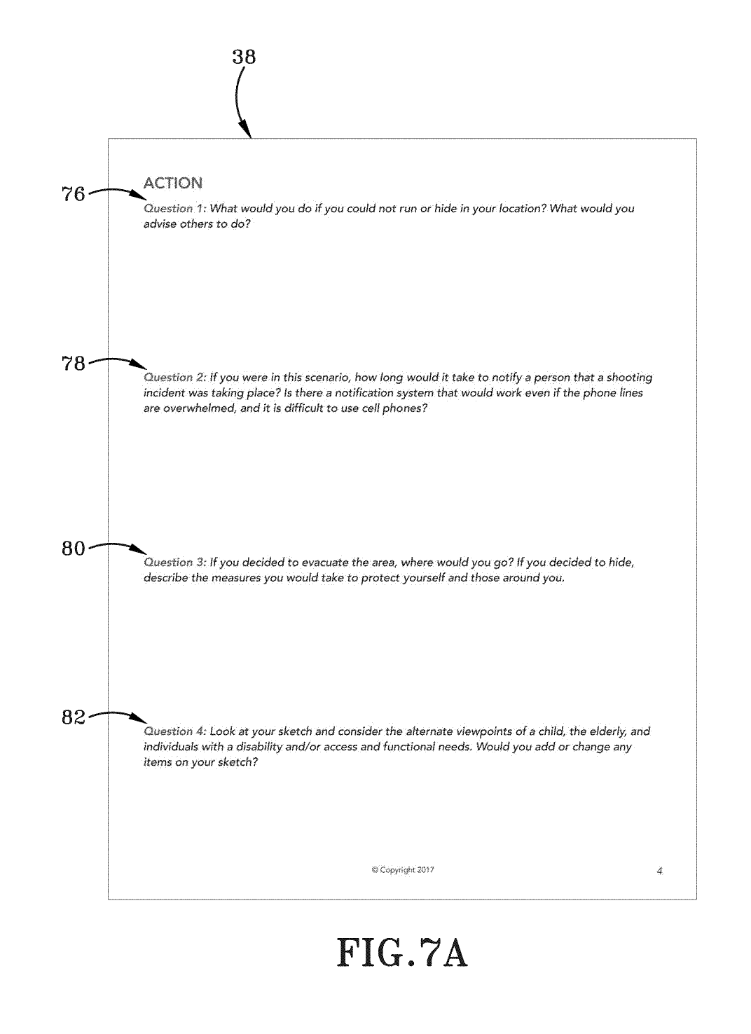

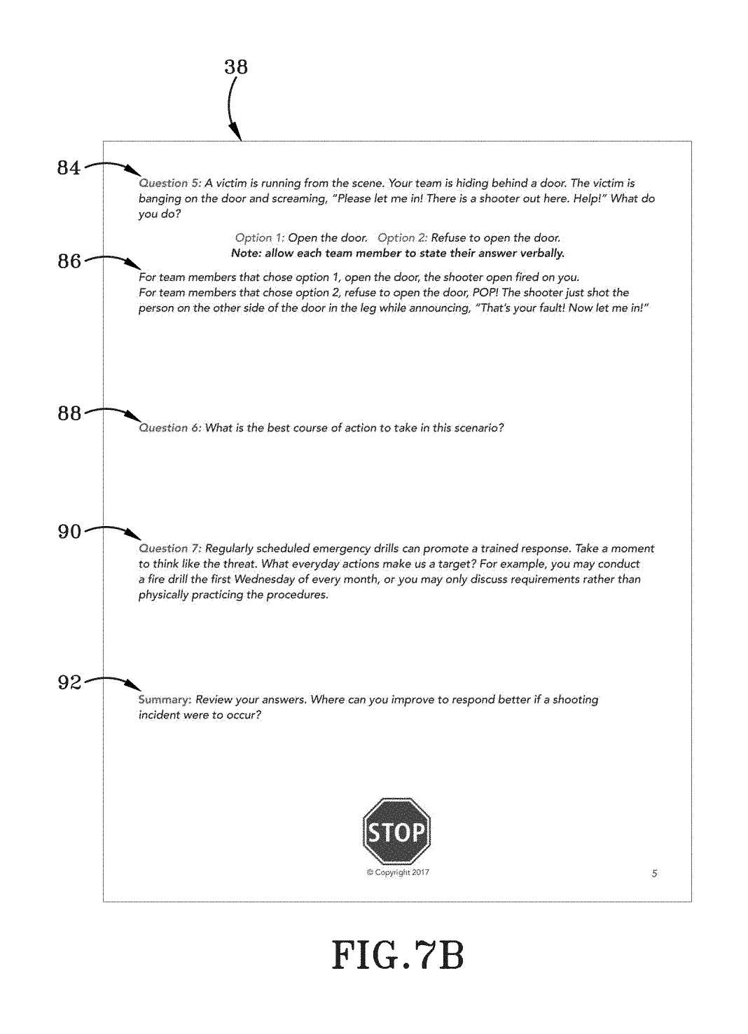

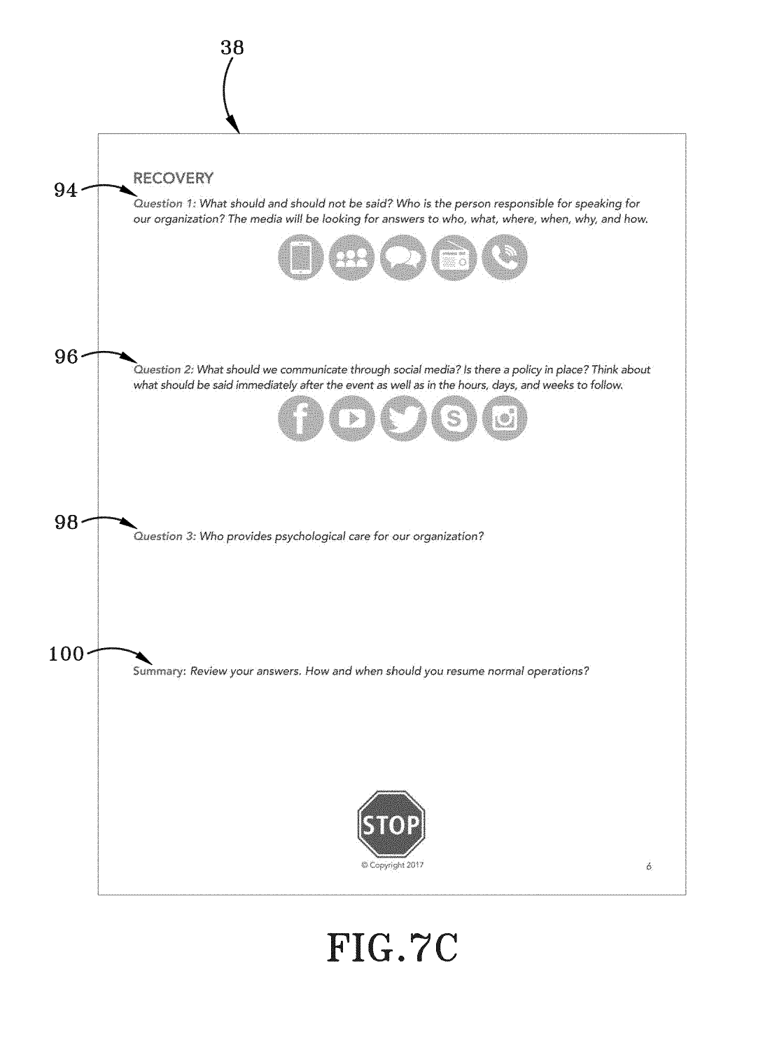

FIG. 7 depicts an exemplary fourth page of the facilitator's guide 28. An emergency is represented at 72. In one particular embodiment, emergency 74 corresponds to an active shooter situation in which the facilitator tells the teams that someone nearby has heard a gunshot. The teams are then provided a time period to work through questions identified on exemplary pages 4 and 5 of the facilitator's guide 28. The participants are encourage to communicate to identify various needs, which is shown generally at 74. Some exemplary prompts relative to the needs that are identified at 74 relate to whether the individual should run to a safe place or hide in their current location. Alternatively, what should be done to secure the area? Further, are all individuals being considered? Who and how are the right people contacted? Are premade statements prepared for the media and presented by a designated spokesperson? Can psychological care be provided? Are there established relationships and references within the community? What improvements can be made to existing plans, training schedules, and/or equipment?

FIG. 7A, FIG. 7B, and FIG. 7C are an exemplary pages from workbook 38 associated with the facilitator guide 28 prompts from FIG. 7. FIG. 7A depicts at least one prompt 76 relating to actions that the participants make take during an emergency. For example, the first prompt 76 requires the participants to address what they would do if they could not run or hide in their location, or what would be advisable to others. The second prompt 78 requires participants to address how long it would take them to notify emergency personnel (i.e., call 911), and address other difficulties associated with the same. The third prompt 80 requires the participants to address how they could evacuate from their location, and address other difficulties associated with the same, or vulnerabilities for remaining in place. The fourth prompt 82 requires participants to address their surroundings and location and view them from the viewpoint of a child, or elderly, or disabled person and how the location should be altered to assist with these types of needs during the emergency scenario.

FIG. 7B depicts a fifth prompt 84 in the workbook 38 that is a prompt that provides the participants with two optional answers. However, in other scenarios more than two or fewer than two answers may be provided. For example, the fifth prompt 84 may indicate that a victim is approaching your location and your group is locked behind the door. The victim indicates that the active shooter is in the hallway. Would the group unlock the door to let the victim in (i.e. option 1) or keep the door locked (i.e., option 2). A consequence 86 may be provide that is responsive to the option that was chosen by the group in the fifth prompt 84. A sixth prompt 88 requires the participant to address the best course of action as a result of the option scenario provided in the fifth prompt 84. A seventh prompt 90 require the participants to address emergency drill scenarios and how every day scenarios may be threatening. A summary 92 can request the participant to address how they would improve their response if the incident were to occur.

FIG. 7C depicts a page from the workbook 38 in which the participants address how the incident should be broadcasted to the public. For example, a first prompt 94 may require the participants to identify a person who should address the media and topics that should be provided to the media and those that should not. Another prompt 96 may address a social media component and what topics should be updates in social media outlets and by whom. Another prompt 98 may require participants to address psychological care. A summary 100 can ask participants to address and provide recommendations as to when normal operations should resume. While these prompts are exemplary, it is to be understood that other prompts are entirely possible so that help the provider evaluate customer vulnerabilities.

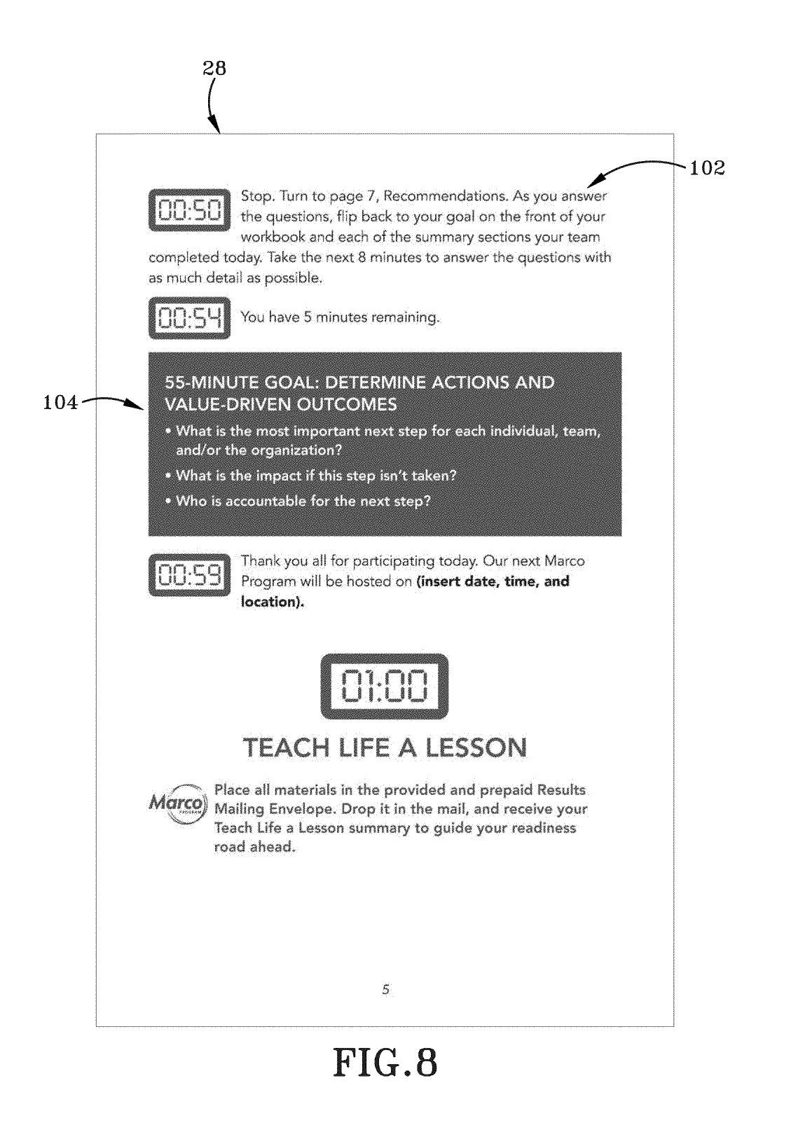

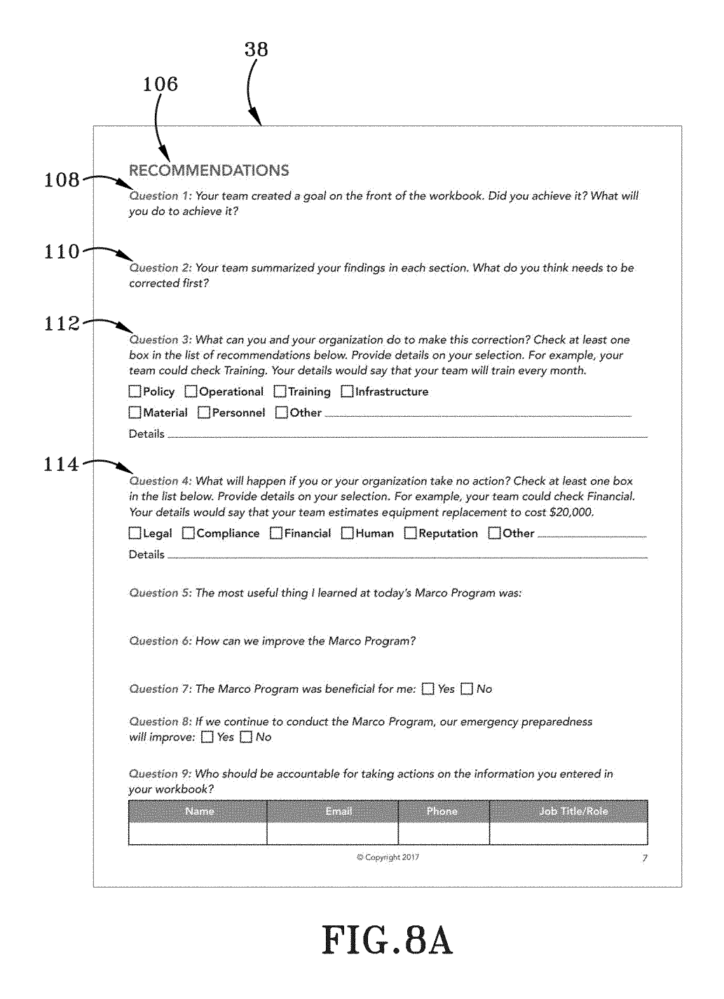

FIG. 8 represents an exemplary fifth page of facilitator's guide 28 in which the facilitator requests recommendations at 102 from the participants. Then, actions and value driven outcomes, which are shown generally at 104, are identified. In some non-limiting examples, the outcomes includes what is the most important next step for each individual team and/or the organization, such as: “What is the impact if this step is not taken? Who is accountable for the next step?” The facilitator can then end the program. Although these recommendations 102 are shown, other recommendations are entirely possible that can query the participants to provide any type of feedback to address or mitigate the vulnerabilities that the participants identified during the scenario prompt. As will be discussed in greater detail below, the provider will analyze the participant-generated recommendations to generate a summary (either long-form or short-form) that provides items to minimize the vulnerabilities.

FIG. 8A is an exemplary page from workbook 38 associated with the facilitator guide 28 prompts from FIG. 8. The workbook may provide spaces for the participants to provide recommendations 85 to the customer 14 and/or the provider 12 including prompts 108, 110 to determine whether the team goals were met and what corrections should first be made. Other prompts may include a prompt 112 directing the organization in a manner as to how the corrections should be made. Another prompt 114 may relate to the consequences resulting from inaction by the company or failing to make the recommended corrections, and identifying an accountable person for the action. Additional prompts in the workbook 38 may relate to general survey questions for the provider to determine the helpfulness of the program. For example, the workbook 38 can include other areas of additional feedback. Further, while the workbook 38 and the feedback or recommendations 85 are shown in paper-format, this may be submitted by the participants in digital format and provided to the provider 12 across link 16.

Referring back to FIG. 2, subsequent to the provider 12 affecting the game or role-playing scenario 22 described above with reference to FIGS. 4-8A, the results of the game or role-playing scenario may then be provided by the customer back to the provider 12 across link 16. Alternatively, the system may be configured to enable the participants to directly submit the results of the game or role-playing scenario directly to the provider 12. This may be accomplished through the use of link 16 in electronic format, such as email or any other electrical telecommunication mechanism or means. The provider may receive the same and may keep the initial results and confidential from the customer 14 as a privacy matter for the participants. In this instance, the individual responses from each or each group of participants can be held in confidence by the provider. The participants may be informed of this confidentiality prior to generating their recommendation to ensure that they feel fully comfortable in providing honest answers and feedback. Once the provider has the feedback from the participants, regardless of how the provider receives the feedback, the generation of an implementation plan or summary (either long-form or short-form) requires the provider 12 to evaluate and analyze the results provided by the participants and teams of the role-playing scenario, which was shown generally at 22. The implementation plan may include an analysis of capabilities and an improvement plan which is described in greater detail below. Then, the provider 14 may provide a business impact analysis, which may also be consider a detailed or long-form summary is shown generally at 26. This may include suggestions or feedback to affect the customer 14 to find a manner to mitigate, prevent, or reduce the vulnerability at its facility. Alternatively, the report may be worded in such a way and include suggestions or feedback in an optimistic and growth orientated format with positive wording (e.g. identify opportunities, raise awareness, improve operations, increase communications, etc.) In some implementations, it has been found that positive or optimistic and growth oriented feedback has been found to be more effective at implementing changes in the customer than feedback in the form of criticism. As depicted in FIG. 3, after the customer 14 has completed the role-playing scenario as led by the exemplary pages identified in FIGS. 4-8, an after action report 48 may be generated from the provider before the generation of an implementation plan, which is shown generally at 24. In some instances, the AAR 48 may be provided to the customer 14. In some implementations the AAR 48 may include a summary. However, in other scenarios a summary may be provided across link 16 independent from the AAR 48. The timing of whether to include the summary with the AAR 48 is variable according the customer 14 needs and/or provider 12 capabilities or bandwidth.

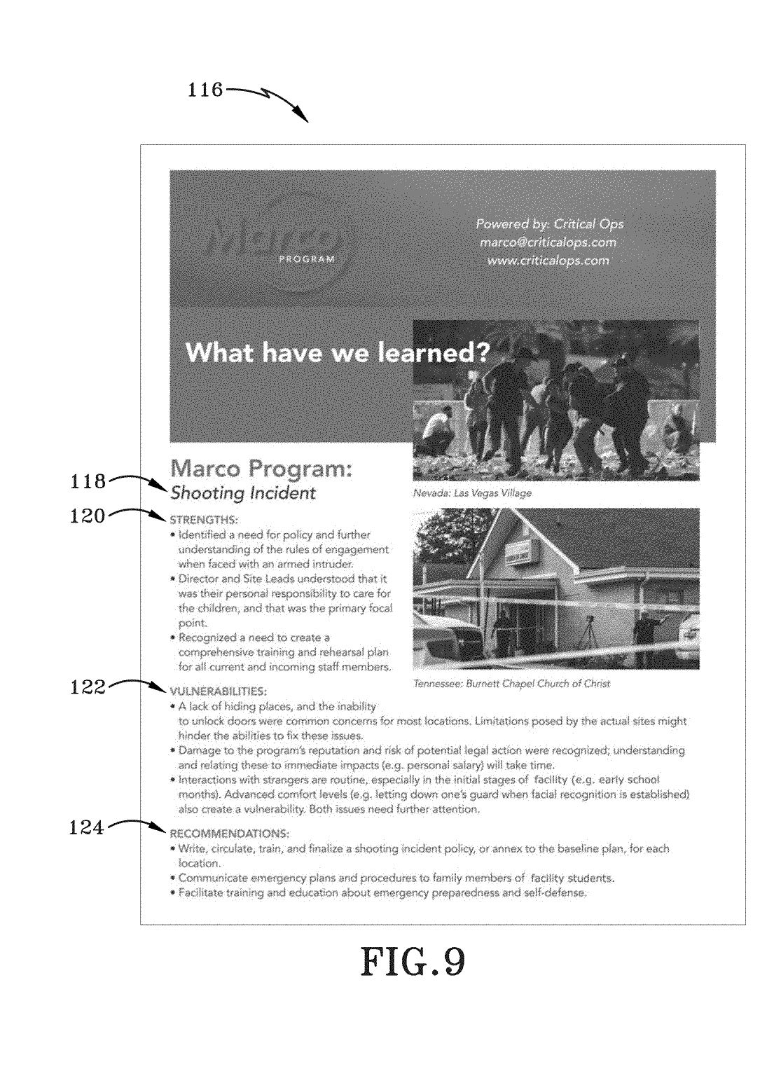

FIG. 9 depicts an exemplary short-form summary which may be provided to the customer 14 by provider 12 across the link. Again, the summary 116 may be provided as part as the AAR 48, or independent from the AAR 48. The summary 116 is generated by the provider 12 in response to reviewing the results obtained from the participants of the scenario 22. The provider 12 may generate the summary 116 in any suitable format. However, it is envisioned that the summary will either be a hard copy or provided to the customer 14 in a PDF format. The summary 116 identifies the scenario type 118 and then addresses the strengths 120, the vulnerabilities 122, and provides recommendations 124. For example, the identified strengths 120 may include the identification of a need for policy and further understanding of rules of engagement when faced with an armed intruder or active shooter. Other identified strengths may include the understanding of certain individuals to recognize responsibilities to care for others, such as children. The vulnerabilities 122 identified in the summary 116 may include a lack of hiding places, and the inabilities to unlock doors. Additional vulnerabilities 122 include damage to reputation and risks of potential legal action, and the understanding and relating these vulnerabilities to immediate impacts take more time.

In one particular embodiment, the short-from summary 116 (or long-form summary, introduced below) may be generated by a human-operator associated with the provider reviewing the responses that the customer provided across the link. Alternatively, the provider may generate the summary 116 by implementing a computer automated process that eliminates the need for human-operator review of the customer response. In these instances, some of the responses from the scenario prompt may be fed/provided into an algorithmic evaluation by a computer hosted by the provider. The manner in which the customer supplies its responses to the provider computer can be accomplished in a number of different ways. For example, the customer responses may be provided in a scantron format that is fed into the computer with digital code generated in response to the answers bubbled in with a pencil. Alternatively, the participants in the scenario prompt of the customer may write-in their responses which may be scanned into the computer that are digitized via optical character recognition (OCR). Further alternatively, the responses may be input by the participants of the customer directly into a computer that supplies answers to the provider computer across the link. The computer may implement operations to evaluate the responses based on a preset database of potential responses. The database may include a set of responses to provide in the summary when the customers answers questions from the scenario prompt in a certain manner. For example, if one of the customer responses to the game or scenario prompt was that there was an insufficient exit or escape, then the automated summary database may populate the summary with responses pertaining to the need for additional exits. Further, the database may be filled with a list or contact information of third-parties that can assist with the construction of an exit, such as a general contractor, or with the contact information of companies that supply exits supplies, such as lighted placards.

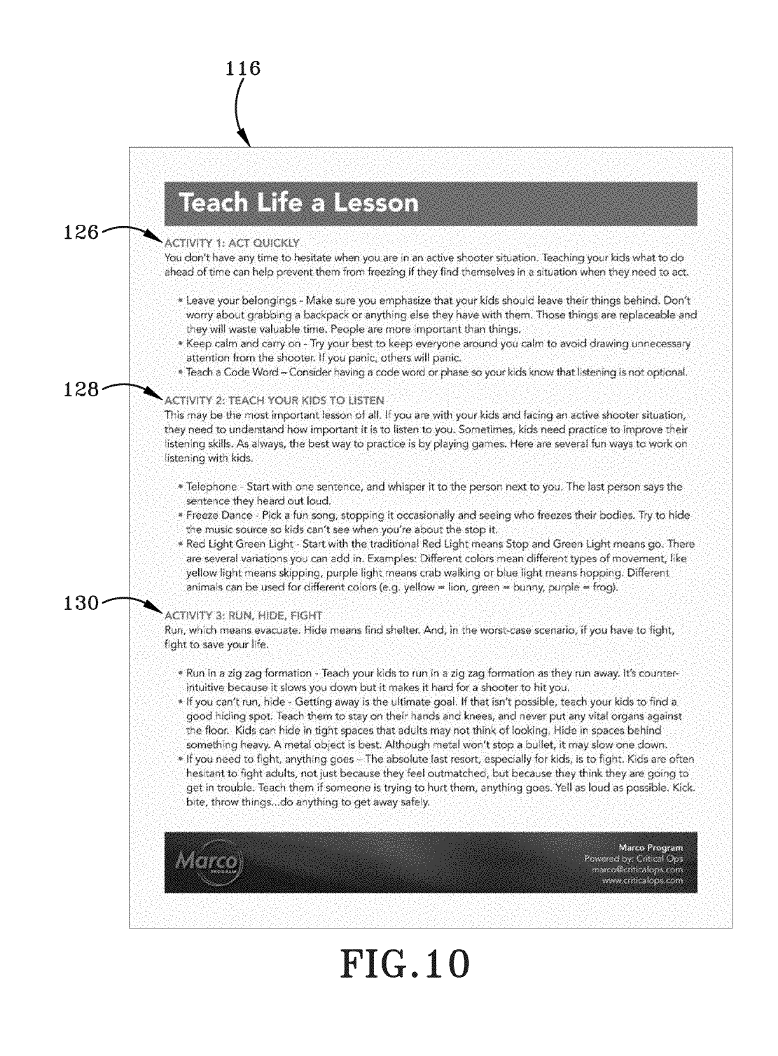

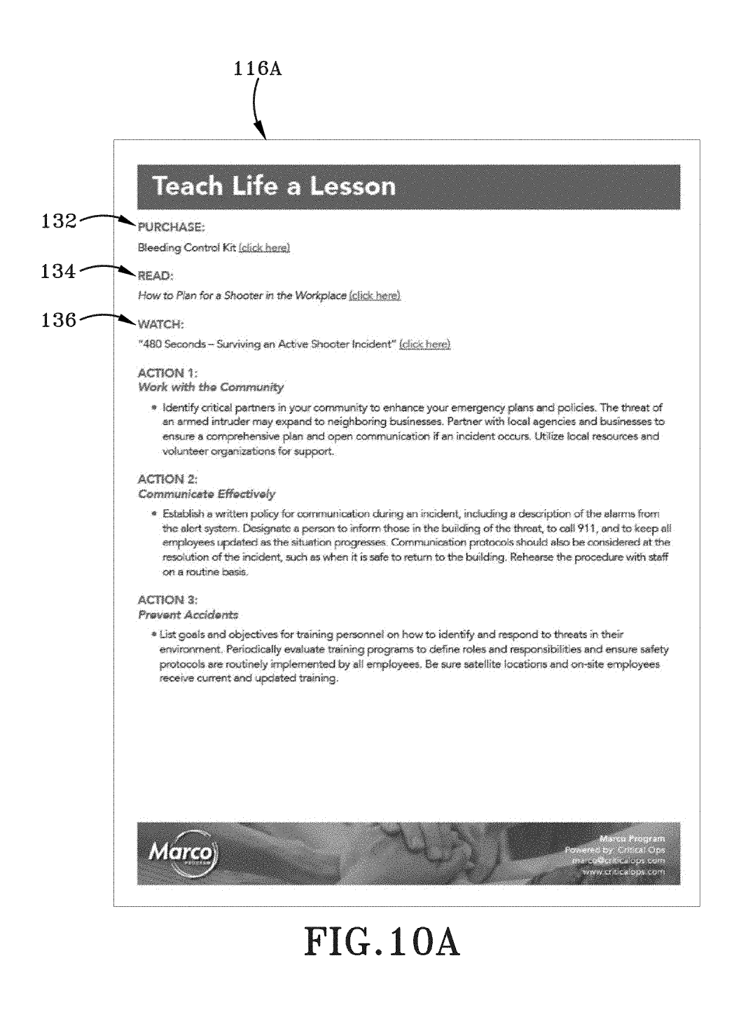

FIG. 10 depicts a further exemplary aspect of the method and system 10. Particularly, the summary 116 utilizes the identified vulnerabilities 122 and provides a variety of recommendations, which may be in the form of an action call, of activities, actions, articles/periodicals, or products that can address the vulnerabilities. In one particular embodiment, and activity 126 may be recommending activities in response to the identified vulnerability 122. For example, a first activity 126 can provide action calls for participants to act quickly. The first activity 126 can teach or recommend actions that allow one to “act quickly.” For example, because the vulnerability 122 identified that the doors of the facility did not lock, the system 10 can generate the first activity 126 to teach persons to act quickly to lock the doors. The first activity 126 provides a source of data that enables the provider to review the same in order to recommend solutions that, when implemented, can help the person to act quickly in response to an active shooter emergency scenario 22. For example, the first activity 126 can require a person to leave their belongings behind, to keep calm and carry on, and/or teach a code word(s). The summary may continue to provide other activities, such as the second activity 128 and the third activity 130. In another alternative example, if the role-playing scenario related to the emergency of a fire in the building, then the summary 116 may include products related to fire safety, such as smoke alarms or fire extinguishers.

Notably, the activities (or articles or products) identified in the summary 116 responsive to the vulnerabilities 122 can be altered or broadened to general recommendations. For example, an exemplary recommendation can be for a product that could solve an identified vulnerability, such as when participants identified that some door do not have locks. In this instance, the summary can recommend a door lock that would solve or alleviate the vulnerability.

When the summary 116 recommends certain products in response to the identified vulnerability, other aspects should be addressed. For example, the provider 12 should be absolved from liability inasmuch as the general purpose warranties as to the effectiveness should remain with the product's manufacturer. Further, profit models can be implemented by contracting with certain manufacturers, consultants or other not-for-profit organizations and/or for-profit organizations and the like, to become a preferred recommendation. For example, if the customer 14 purchases a lock based on the provider's recommendation in the summary 116, the provider may receive a percentage of the sale. This recommendation royalty may be paid directly from the manufacturer, or it may be paid through an online commerce provider. However, the payment terms or royalty incentives may be varied according to differing business models.

Additionally, the summary 116 can further provide additional follow up reading materials to address the vulnerabilities 122. This would be in addition to various products or activities. For example, one of the recommendations could be to a recent article for how to prepare for gun violence. Other periodicals or news articles or tips or checklists could similarly be provided.

FIG. 10A depicts an alternative summary 116A which may provide a product to purchase 132, an article to read 134, or a video to watch 136, all of which may relate to recommendations by the provider to address the vulnerabilities identified as a result of completing the program or role-playing scenario. This summary 116A may also provide three activities or actions, similar to those addressed above in summary 116 (FIG. 10).

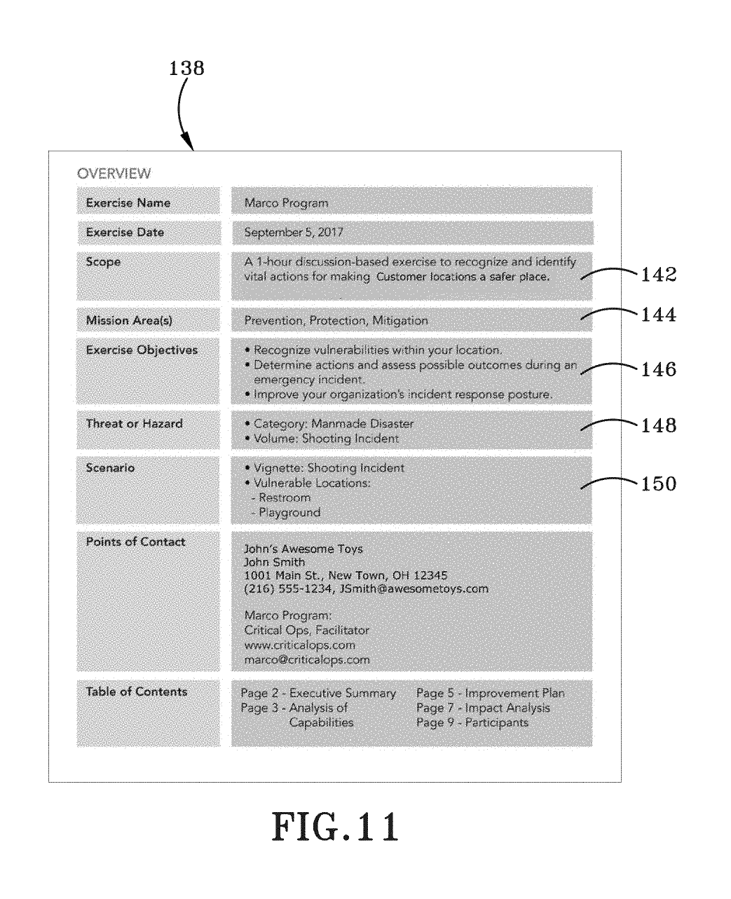

In some instances it may be more advantageous to provide a detailed summary rather than the short form summary 116. An overview 138 of the detailed executive summary 140, which is shown generally at FIG. 11, may include a scope summary 142, a description of the mission area 144, a summary of objectives 146, a hazard or threat type 148, a summary of scenario 150 and other relevant information, such as points of contact and a table of contents.

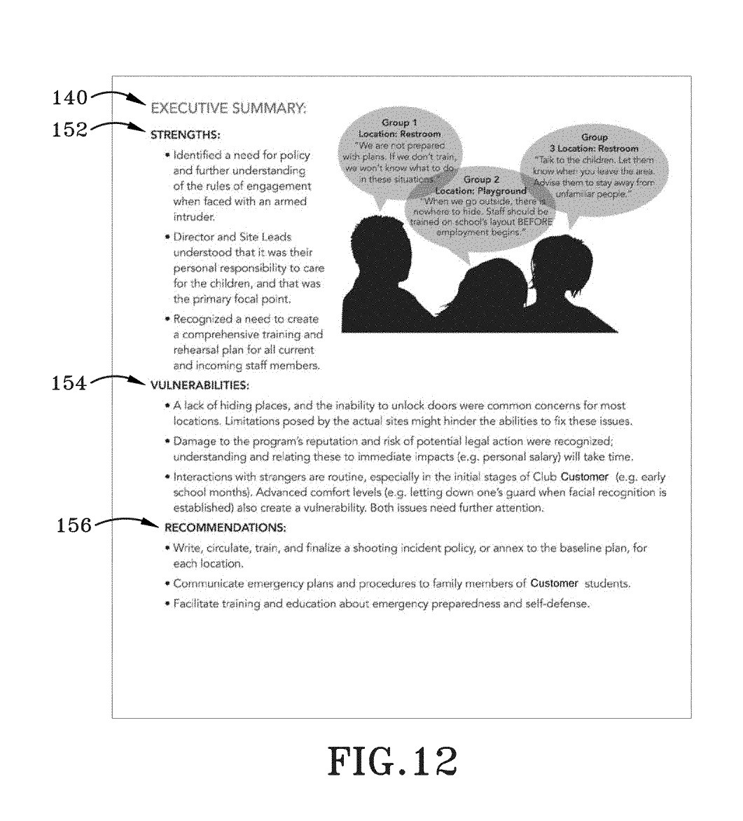

FIG. 12 depicts the exemplary detailed executive summary 140 provided by the provider 12 to the customer 14 in response to the completion of the role-playing scenario at 22. The executive summary 140 may include strengths 152, vulnerabilities 154, and recommendations 156. In the scenario 150 comprising an active shooting incident, the vulnerability 154 can identify a lack of hiding places and the inability to unlock doors that may be common concerns for most locations. Alternatively, provider 12 may include in the vulnerability 154 a list of common concerns provided by the participants of the role-playing scenario 22. Another vulnerability 154 may be identified, such as the damage to reputation and potential legal action.

The executive summary 140 identifies strengths 152, such as the need for policy and further understanding of the rules of engagement when faced with an armed intruder or another scenario 150. Some other strengths 152 can be identified that are fact dependent on the facility of the customer 14 and the scenario 150.

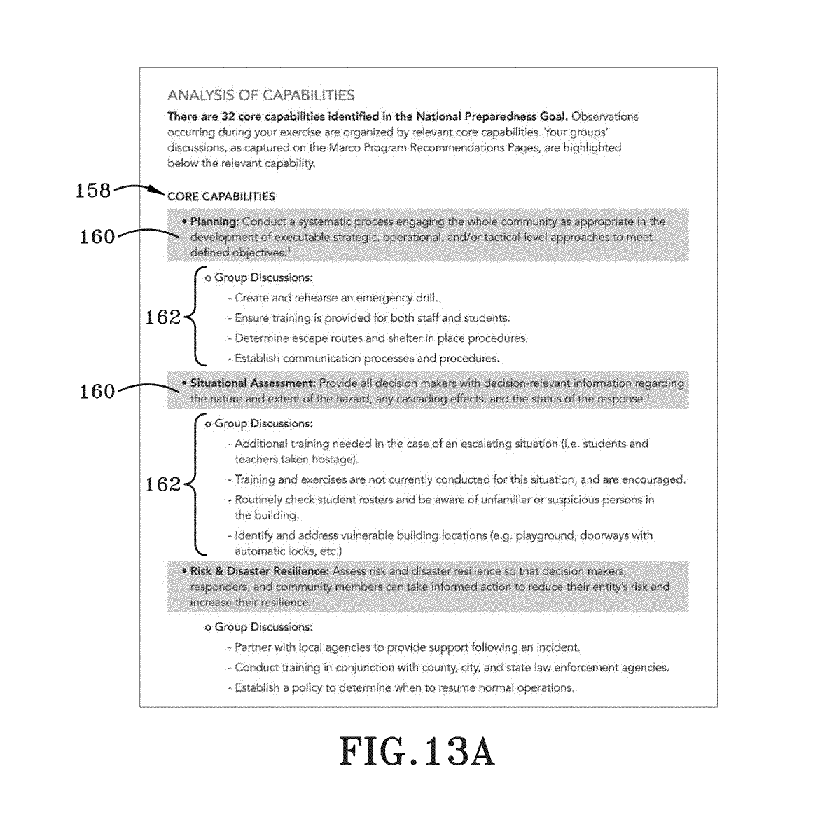

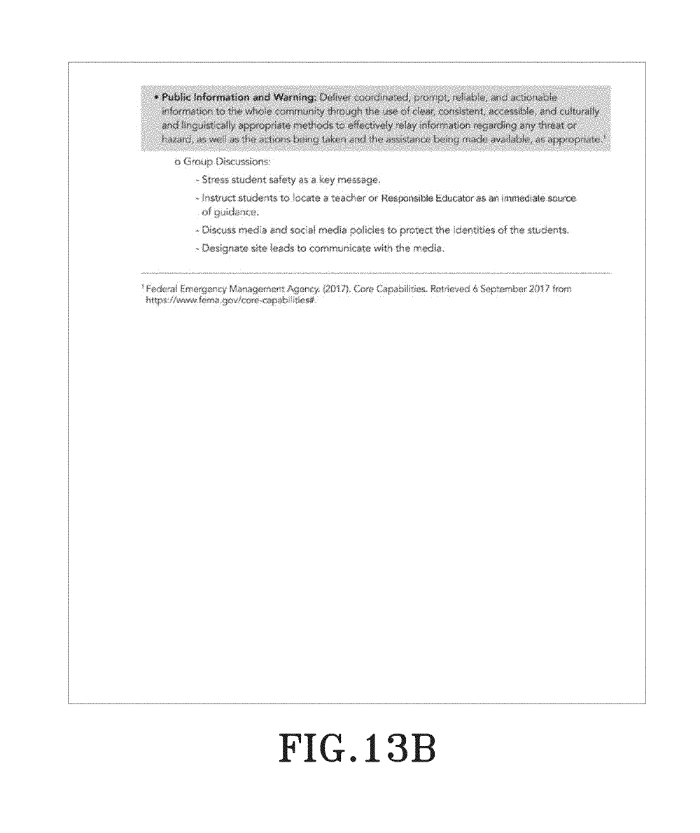

FIG. 13A and FIG. 13B depicts an exemplary analysis of the capabilities provided by the provider 12 to the customer 14 inside the implementation plan. In one particular example, the analysis of capabilities takes predefined goals and evaluates participant responses from the role-playing scenario 150 and details them relative to the predetermined goal set. In one particular example, there are thirty two core capabilities identified in the national preparedness goal. The analysis of capabilities details the observations recorded by the participants during the exercise relevant to core capabilities. Some exemplary core capabilities 158 include planning, situational assessment, risk and disaster resilience, and public information and warning. Within the core capabilities identified in the analysis, a general definition 160 is shown of the respective capability. Group discussion points identified at 162 are provided in a legible format to the customer 14. For example, the planning capability is configured to conduct a systematic process engaging the whole community as appropriate in the development of executable strategic, operational, or tactical level approaches to meet defined objectives 10. Then, in the group discussions at 162, the participants from the role-playing scenario 22 indicated that for an active shooter scenario 150, the customer 14 should create and rehearse an emergency drill. Additionally, the customer 14 should insure training is provided for both staff and students, determining escape routes and shelter in place procedures, and establish a communication process and procedure. Similar capabilities and group discussions are further provided so as to enable the provider 12 to evaluate the responses of the participants at 162 relative to the respective capability 158 and its given definition 160.

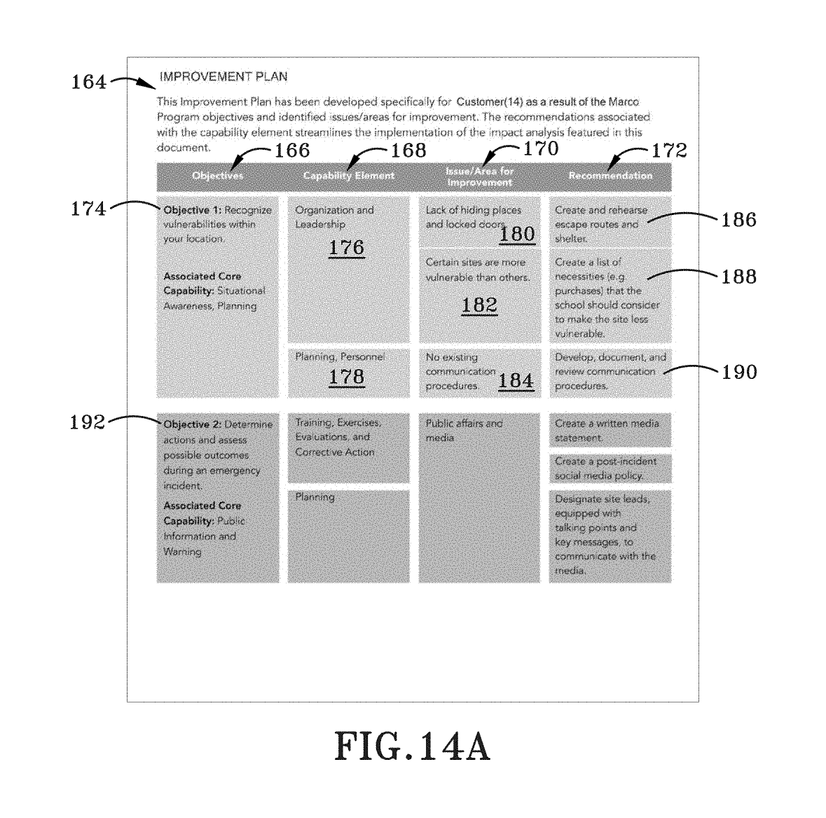

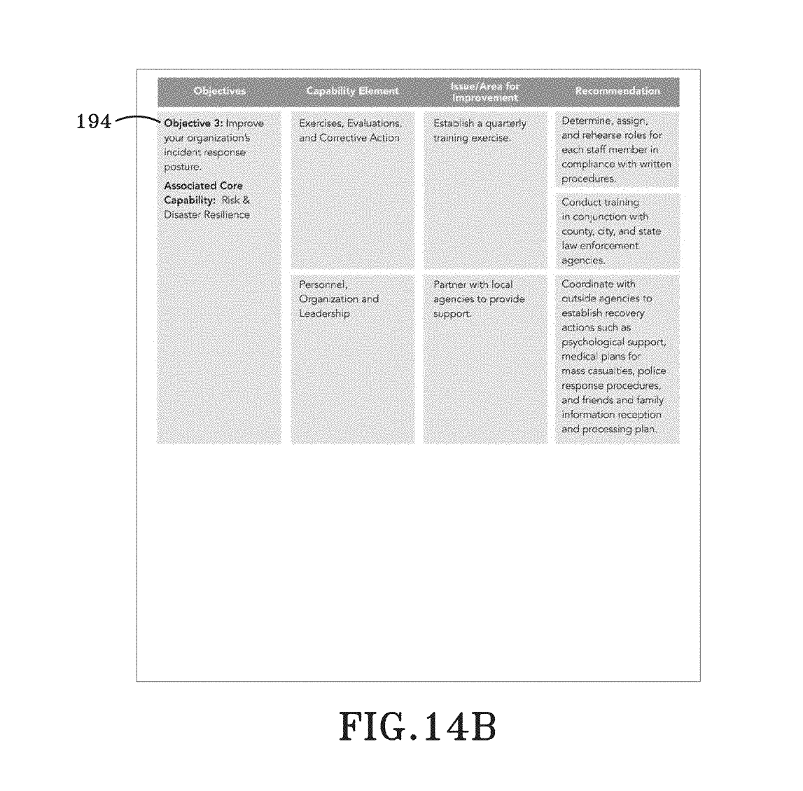

FIG. 14A and FIG. 14B depicts an improvement plan generally at 164. The improvement plan which is a subset of the business impact analysis identifies objectives 166, capability elements 168, issues or areas for improvement 170, and recommendations 172. Some exemplary objectives 166 may be broken out into first and second objectives as depicted in FIG. 7. The manner in which the objectives may be broken out may be accomplished through a manual or an automated process. An automated process may take advantage of an algorithm or methodology accounting for the objective goals, the scenario prompt, and the responses to the scenario prompt provided by the customer. The automated process may take advantage of predictive algorithms or responsive algorithms. When implemented as a predictive algorithm or methodology, the provider may predict goals of the objectives prior to receiving or fully reviewing the responses/data provided by the customer. The automation of the objective analysis may be accomplished through automated logic stored in a computer server, preferably maintained by provider, that, when executed by one or more processors, implement operations to predictively or responsively separate the objectives into the first and second object goals.

Further, the provider may choose when to separate the objectives 166 into the first and second objectives. In one particular embodiment, the provider breaks out or separates the objectives subsequent to evaluating the results of the scenario prompt. It may be more valuable to separate the objectives after evaluating the results or data of the scenario prompt because the provider would typically not know the results until after completing the scenario prompt. However, it would be possible to pre-arrange the first and second objectives, by the provider, prior to reviewing the results of the scenario prompt by the customer.

Regardless of the manner and timing in which the objectives are segregated or broken out, the objectives may be grouped according to sub-objectives. The sub-objectives may be categories that they intend to accomplish. For example, the first objective 174 may be to recognize vulnerabilities within a location. The first objective 174 may have an associated core capability related to situational awareness and planning. From the first objective 174, capability elements 168 may be broken down into subsets, namely, an organization and leadership subset 176 and a planning and personnel subset 178. Similarly, the provider may further break down the subset of organization/leadership and planning/personnel subsequent to the reviewing the data and results/responses of the customer after completing the game or scenario prompt. In one particular example, it may be beneficial to perform the breakdown of the capability elements after reviewing the capabilities of the customer facility in conjunction with a review of the customer responses to the scenario prompt.

The issues and areas for improvement 170 may be associated with the subcategories of the capability of elements 168. For example, lack of hiding places and locked doors 180 and certain sites are more vulnerable 182 may be subsets of the organization and leadership 176 capability element 168. Additionally, the lack of existing communication procedures 184 may be associated with the planning and personnel subset 178 of the capability element 168. A plurality of recommendations 172 may be associated with the areas for improvement 170. For example, for the lack of hiding places 180, the recommendation may be provided to create and rehearse escape routes and shelter, which is shown generally at 186. For the issue and area for improvement 170 relating to certain sites being more vulnerable than others 182, the recommendation may be to create a list of necessities that the facility should consider to make the site less vulnerable, which is shown generally at 188. Furthermore, the recommendation of developing, documenting and reviewing communication procedures may be associated with the area of improvement for no existing communication procedures 184. The recommendation for development of documentation and reviewing communication procedures is shown generally at 190. A similar detailed analysis which provides recommendations 172 in response to the issues and areas for improvement 170 may be associated with the second objective 192 and a third objective 194.

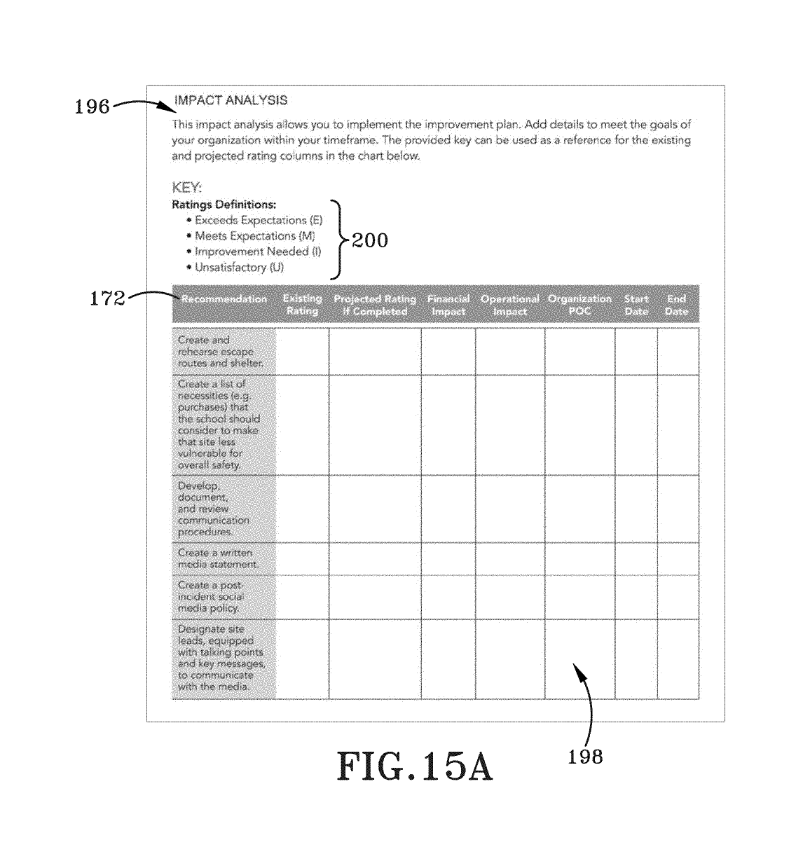

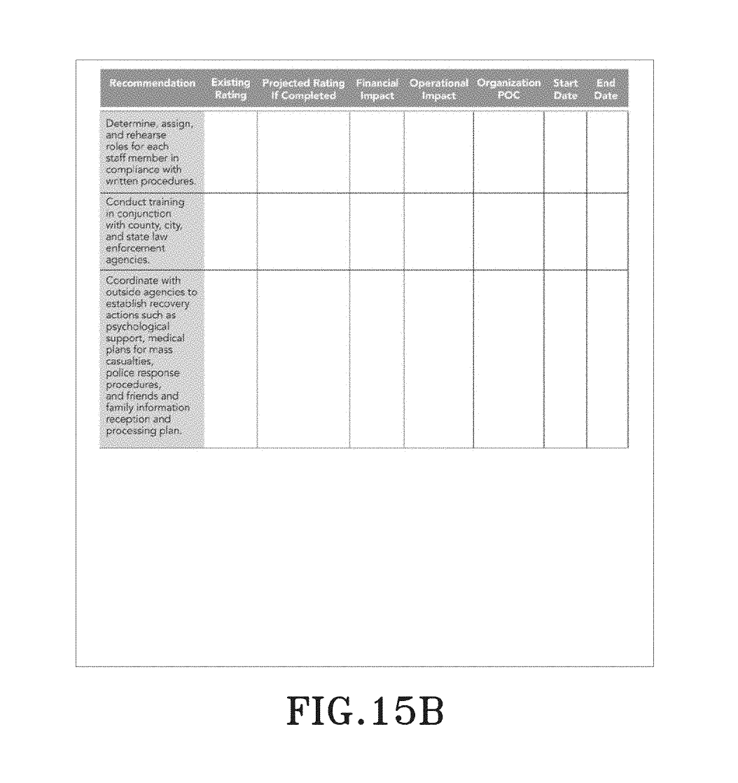

FIG. 15A and FIG. 15B depicts a business impact analysis 196. The impact analysis 106 provided by the provider 12 to the customer 14 allows the customer 14 to implement the improvement plan or implementation plan which includes the analysis of capabilities and the improvement plan. The provider 12 encourages and affects the customer 14 to add details to meet the goals of its organization within a specific timeframe. In one particular embodiment, the recommendations 172 in the improvement plan 164 are populated into the impact analysis 196. The recommendations 172 are then provided in a blank table 198 having cells to be populated by the customer 14 in accordance with a predetermined legend or key 200. The customer 14 may use the key 200 to evaluate whether the recommendations 172 are appropriately described and evaluated. A first cell of the table 198 may be associated with an existing rating that the customer 14 perceives the recommendation 172. Thereafter, the table 198 can include a cell relating to the project rating if the recommendation 172 is completed. The table 198 further includes a cell for a financial impact and an operational impact for the recommendation 172, as well as organizational structure and timelines related to start dates and end dates.

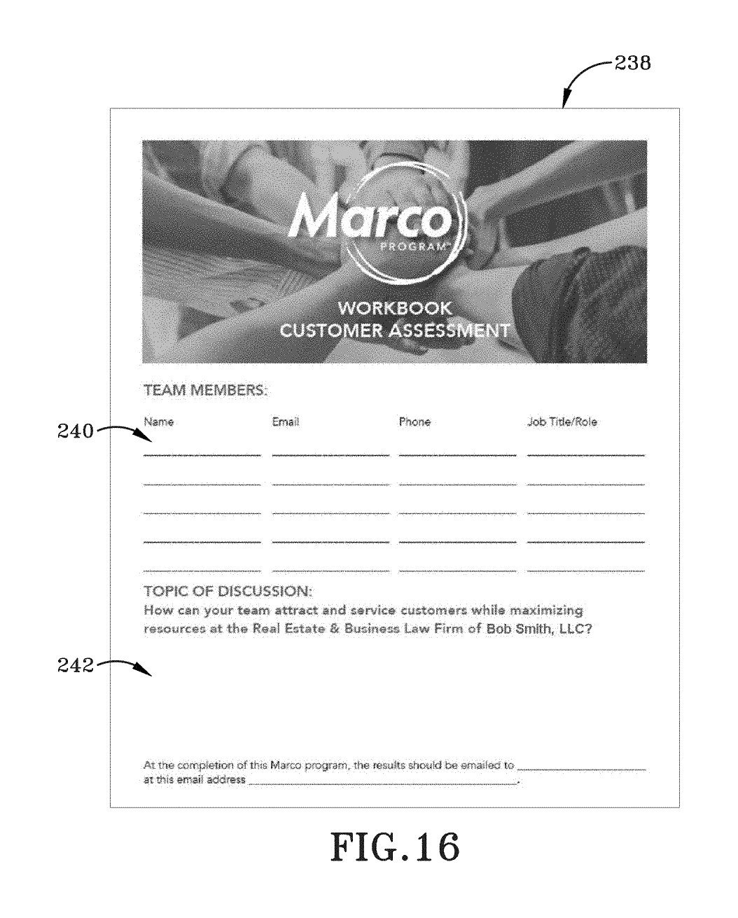

FIG. 16 through FIG. 23 depict an exemplary workbook 238 utilized for non-emergency scenarios that is configured to identify business vulnerabilities. Accordingly, it is to be understood that system 10 may be implemented with workbook 38 or 238 corresponding to an emergency or non-emergency scenario prompt, respectively. As such, system 10 is able to address all types of vulnerabilities for the customer. In this non-limiting and non-emergency scenario, the customer 14 may be a law firm attempting to attract and service clients while maximizing resources at the law firm. For example, business vulnerabilities that are non-life threatening may relate to a decrease in revenue or lost sales leads or the like. While not shown herein, it is to be understood that the facilitator would have a corresponding guide to facilitate the discussions for the role-playing scenario for the non-emergency situation.

FIG. 16 depicts a front page of the workbook 238 for the non-emergency where the participants of the customer 14 may enter names 240 of the participants. Additional contact information may also be provided. The front page of the workbook 238 may also include the topic of discussion at 242 for the customer. In this non-limiting instance, the customer is a law firm looking to attempting to attract and service clients while maximizing resources at the law firm.

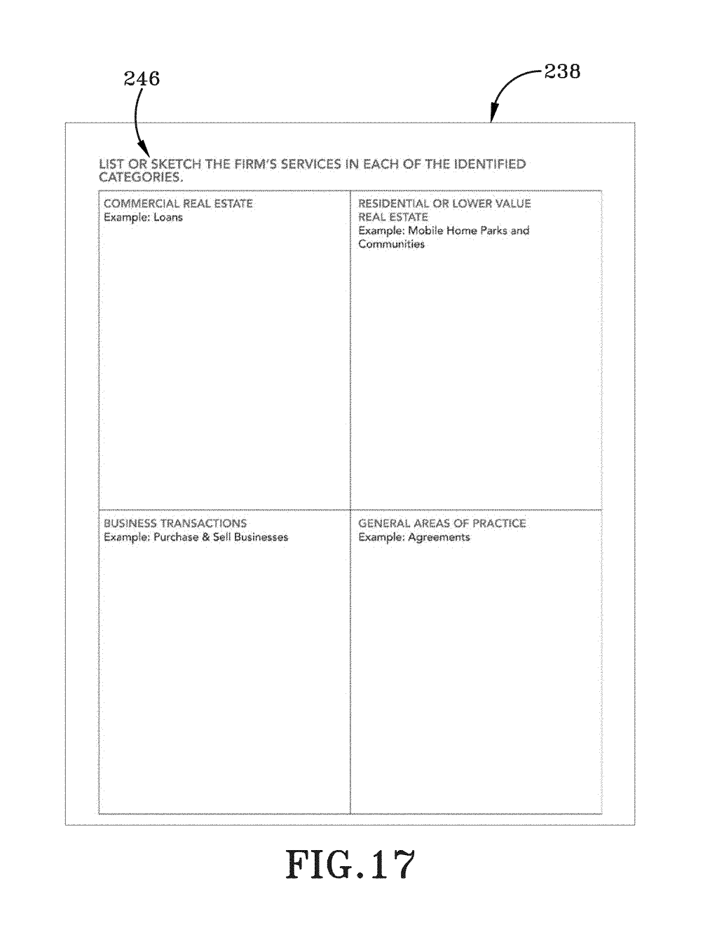

FIG. 17 depicts an exemplary second page of the workbook 238 for the non-emergency scenario prompt. The participants may sketch or list the law firm's (i.e., customer 14) services based on a number of categories, shown generally at 246. In the particular example, the law firm offers commercial real estate services, residential legal services, business transactions, and general legal practice. Each of the services may be divided into quadrants in the workbook that leaves sufficient space for the participants to draw or list the services in each particular category.

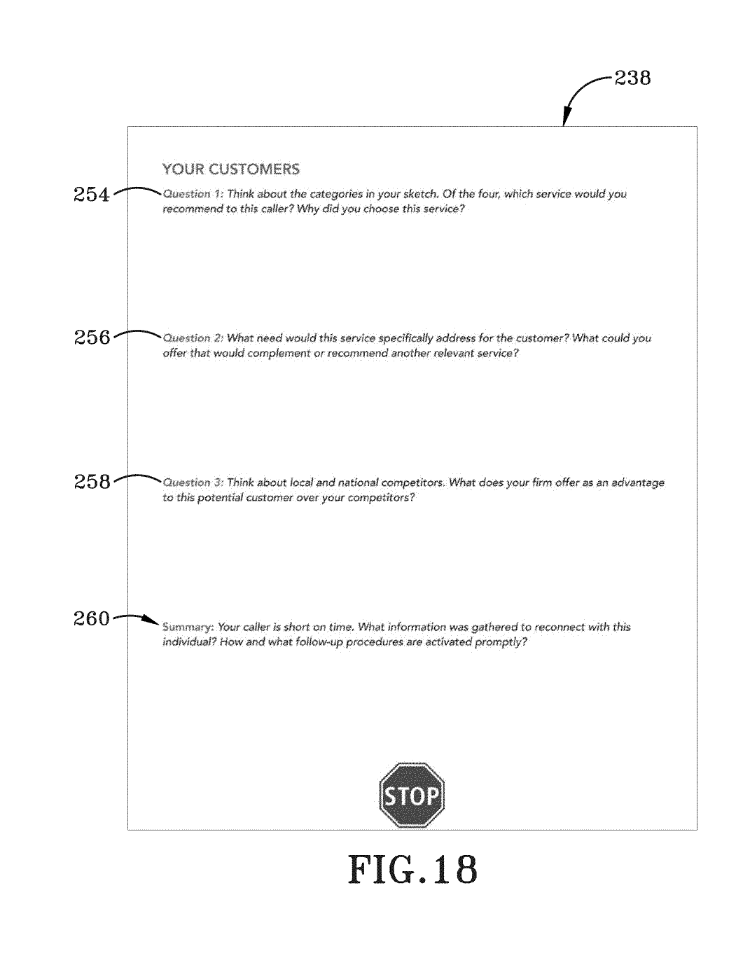

FIG. 18 depicts an exemplary third page of the workbook 238 for the non-emergency scenario prompt. For example, the workbook 238 may include at least one prompt 254 associated with the non-emergency scenario of which services the law firm can provide to a potential client. There may also be a second prompt 256 and a third prompt 258. The second and third prompts 256, 258 in the workbook 238 require the participants to answer “when, where, and what” type of non-emergency services that the potential needs that the law firm (i.e., customer 14) can provide. The workbook 238 also may provide a summary section 260 for the participants to develop recommendations based on their answers to the prompts 254, 256, 258. Notably, while these prompts have been tailored to a non-emergency law firm client scenario, it is understood that the prompts will be re-written to identify vulnerabilities for any of the other emergency and non-emergency scenarios presented above.

With continued reference to FIG. 18, the program then can require participants to place a variety of stickers (or other mechanisms, real or virtual, to identify areas either physically or in a virtual or augmented reality setting) onto a page representing their services provide. The sticker or other identifiers may be associated with types of services offered, or concepts that identify frame-of mind, and/or other means to provide various reference points used based upon the overarching concept of the program being administered.

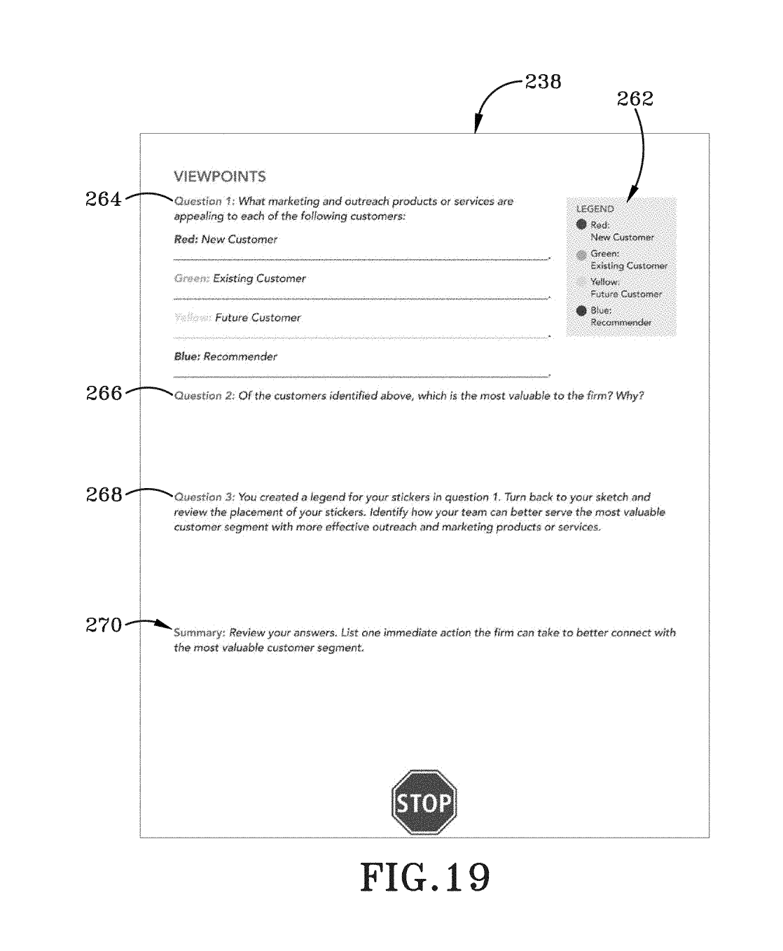

FIG. 19 depicts an exemplary fourth page of the workbook 238 for the non-emergency scenario prompt. For example, the workbook 238 may include a legend or key that associates different colors with different types of clients or customers of the law firm. Within the notebook 238, the participants may place use a variety of colored pens, shown general at 262 representing different types of clients of the firm. This page may include at least one prompt 264 asking the participants what types of marketing efforts work best for each type of client 262. Second and third prompts 266, 268 then require participants to address how specifically the non-emergency scenario will apply to those persons/clients. For example, in a law firm marketing scenario, as indicated by second prompt 266, which types of clients are most valuable to the firm. Additionally, as indicated by the third prompt 268, how the frim can create an effective outreach to each of these clients. This page of the workbook 238 may also include a summary 270 or review to enable participants to identify how their team can best connect with these potential clients.

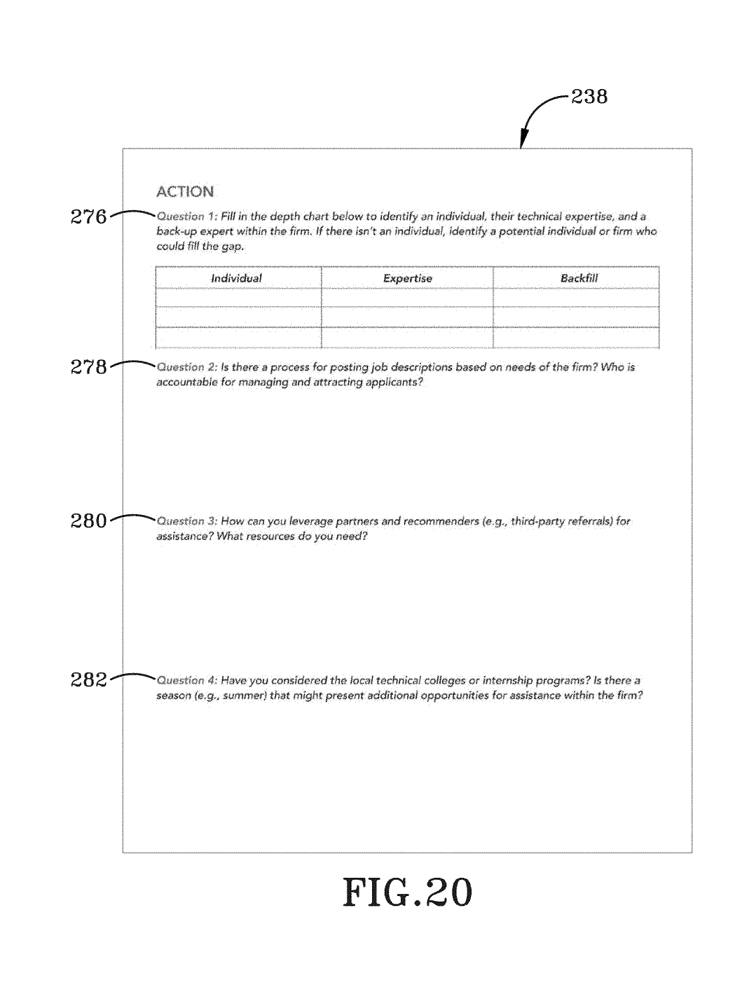

FIG. 20 depicts an exemplary fifth page of the workbook 238 for the non-emergency scenario prompt. For example, the workbook 238 may include at least one prompt 276 relating to skillsets that the participants have that set up the firm's success. For example, the first prompt 276 requires the participants to address how they use their skillsets to advance the firm or potentially attract new employees. The second prompt 278 requires participants to address how attract new employees based on the needs of the firm and whether there are guidelines in place for attracting the same. The third prompt 280 requires the participants to address how they could leverage referrals to convert potential clients into actual clients of the firm. The fourth prompt 282 requires participants to address other external resources that may be available to supplement employment needs of the firm.

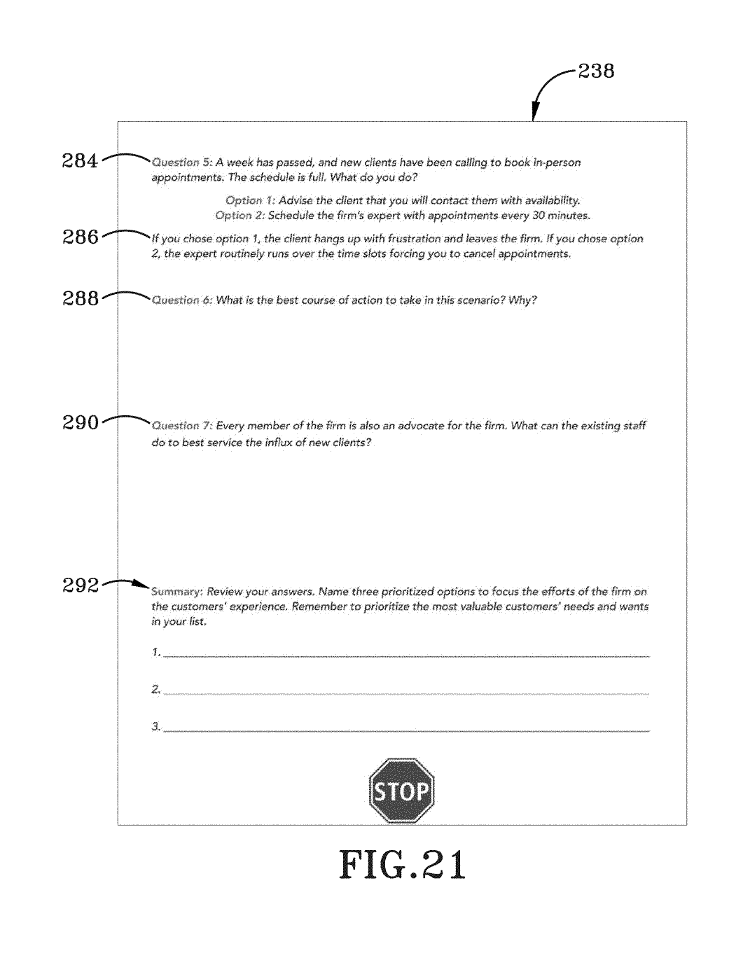

FIG. 21 depicts a fifth prompt 284 in the workbook 238 that is a prompt that provides the participants with two optional answers. However, in other scenarios more than two or fewer than two answers may be provided. For example, the fifth prompt 284 may indicate that a potential client is calling the firm, but the schedule is full. What should you do? Would the employee advise the potential client that they will call them back with potential availability (i.e. option 1) or schedule the firm's lawyer in that specialty are with an appointment (i.e., option 2). A consequence 286 may be provide that is responsive to the option that was chosen by the group in the fifth prompt 284. A sixth prompt 288 requires the participant to address the best course of action as a result of the option scenario provided in the fifth prompt 284. A seventh prompt 290 require the participants to address the non-emergency scenario and what each staff member can do to best service the influx of new clients. A summary 292 can request the participant to address how they would improve their response if the non-emergency were to occur.

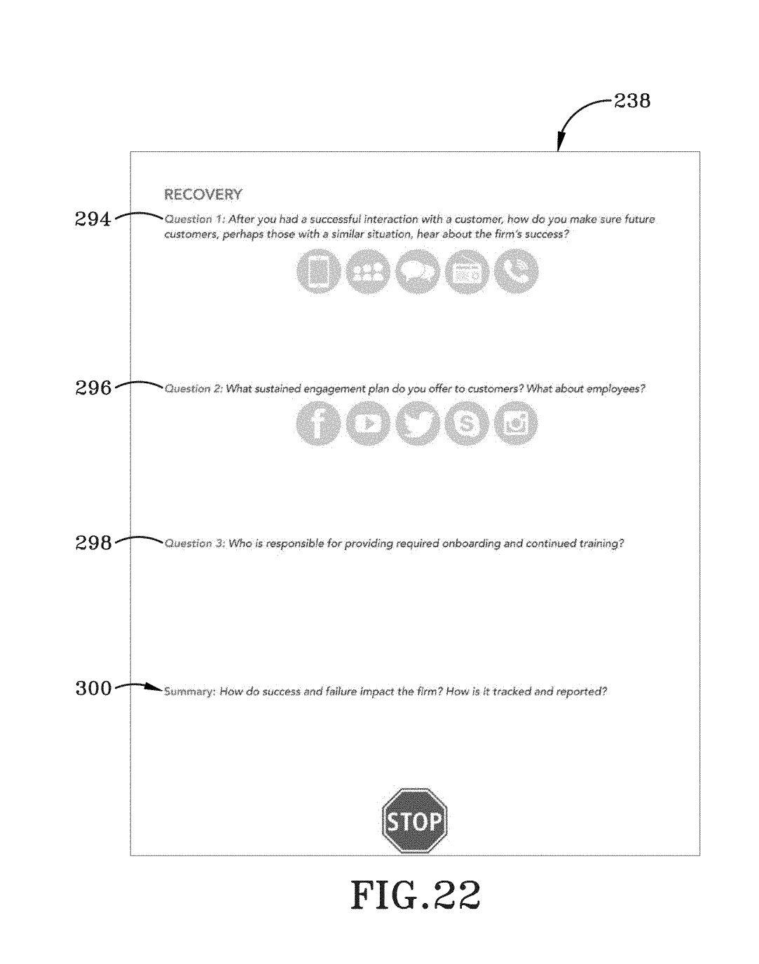

FIG. 22 depicts another exemplary page from the workbook 238 for the non-emergency scenario in which the participants address how the incident should be broadcasted to the public. For example, a first prompt 294 may require the participants to identify a person who should ensure that future clients are aware of the success that the firm was able to achieve for other clients, without violating attorney-client privilege or violating other state-specific rules pertaining to Professional Responsibility. Another prompt 296 may address a social media component pertaining to sustained engagement opportunities with customers. Another prompt 298 may require participants to address who is responsible for onboarding. A summary 300 can ask participants to address how success and failures impact the firm. While these prompts are exemplary, it is to be understood that other prompts are entirely possible so that help the provider evaluate customer vulnerabilities.

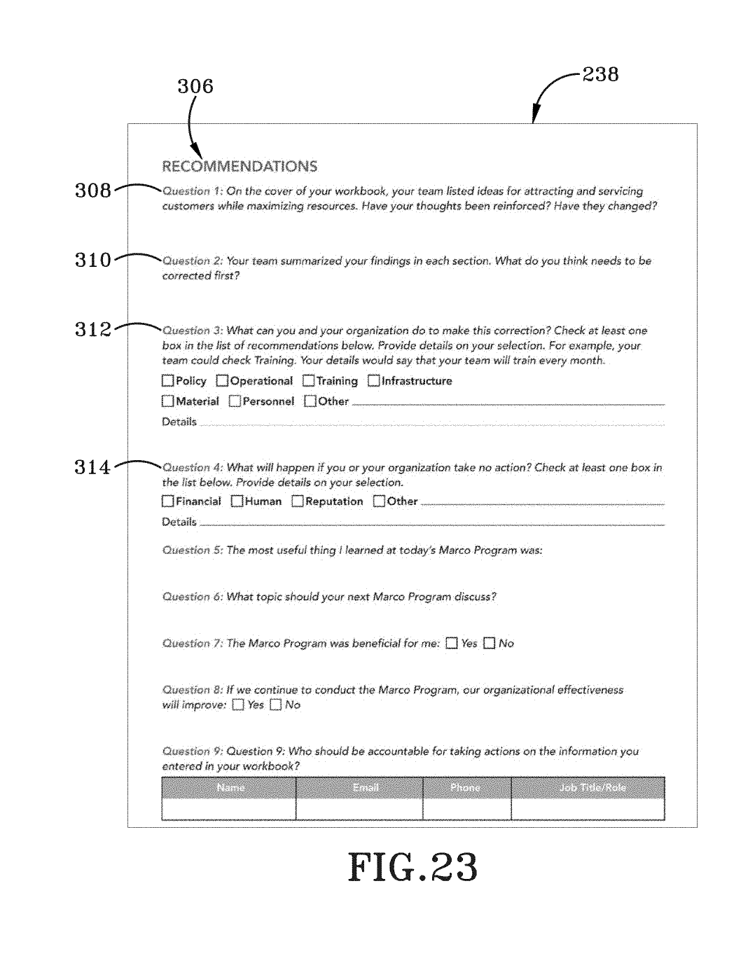

FIG. 23 depicts another exemplary page from the workbook 238 for the non-emergency scenario in which the participants provide recommendations at 306. The workbook may provide spaces for the participants to provide recommendations 306 to the customer 14 and/or the provider 12 including prompts 308, 310 to determine whether the team goals were met and what corrections should first be made. Other prompts may include a prompt 312 directing the organization in a manner as to how the corrections should be made. Another prompt 314 may relate to the consequences resulting from inaction by the company or failing to make the recommended corrections. Additional prompts in the workbook 238 may relate to general survey questions for the provider to determine the helpfulness of the program. For example, the workbook 238 can include other areas of additional feedback. Further, while the workbook 238 and the feedback or recommendations 306 are shown in paper-format, this may be submitted by the participants in digital format and provided to the provider 12 across link 16.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

For example, some exemplary methods of operation of system 10 may include, from the provider's 12 perspective, a method A method for identifying emergency or non-emergency vulnerabilities comprising: providing a role-playing scenario to a customer across a link for the customer to execute; receiving data responses generated by the customer in response to execution of the role-playing scenario; analyzing the data response for vulnerabilities that the customer identified during execution of the role-playing scenario and summarizing the data response in a summary; and providing in the summary, to the customer across the link, an action call recommendation that includes one of a product to purchase, a periodical to read, a video to watch, and an activity to perform adapted to mitigate or remediate one or more of the emergency or non-emergency vulnerabilities.

The method can then accumulates responses from the participants of the customer across the link until a sufficient amount of responses has been accumulated to generate the action call recommendation. Some exemplary action call recommendation may be a command for the customer to improve a physical or virtual facility subsequent to execution of the role-playing scenario. The responses are stored, at least temporarily, in the workbook 38 or 238. However, the facilitator could also store the responses in order to provide the same to the provider 12. In some instances, when the system 10 is implemented via digital platform, the customer or the facilitator may need to compress, digitally, the responses prior to sending the summary to the customer across the link.

Once the provider receives the responses to the scenario prompt, the provider may then begin analyzing the same. During analyzation, the provider may block and remove outlier responses provided during the execution of the role-playing scenario. This is possible when some participants begin to veer off-topic during the role-playing scenario. The provider 12 should have experience to recognize which responses are off-topic and can be removed so that they are not included in the summary report. In generating the summary report for the customer, the provider may customize the summary for addressing the emergency and non-emergency vulnerabilities in response to the data responses generated during the role-playing scenario. The provider may further, according to this exemplary method, derive the action call recommendations from a database of available action call recommendations stored in at least one non-transitory computer readable storage medium located remotely from a physical or virtual facility of the customer; differentiate one action call recommendations from another action call recommendation in the summary; display the differentiated action call recommendations in the summary; embed links in the summary to wireless link connect the customer with an item associated with one response action call recommendation; and distribute the summary over the link 16. In some instances, when the system 10 is implemented via digital platform, the provider may need to compress, digitally, the summary prior to sending the summary to the customer across the link.

In one particular embodiment, the summary need not be fixed. For example, the facilitator or customer may provide the provider responses to the role-playing scenario at different times (i.e., not all at once). In this instance, the provider may alter, dynamically, the summary in response to receiving multiple sets of data response from the customer provided across the link. There may be an opportunity for the provider to receive some financial payment or remuneration from sponsors of products or action call recommendation. For example, the provider may finance a portion of the summary with advertising revenue from a third party associated with at least one products recommended to the customer in one of the action call recommendations provided across the link.

Other exemplary aspects of the method of operation for the provider may include pre-determining, prior to generating the summary, a set of action call recommendations that will be recommended in the summary based on the role-playing scenario executed by the customer. Additionally, the provider may rate, in the summary, an effectiveness of the action call recommendations for the customer based on a rating system independent from the customer.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers or other devices used in the automated processing of information to include platforms used by artificial intelligence. Furthermore, the instructions or software code can be stored in at least one non-transitory computer readable storage medium.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens or holographic generators for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral” and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A system for providing recommendations to address vulnerabilities comprising:
a provider and a customer in operative communication via a link;
a scenario prompt provided by the provider to the customer across the link;
wherein the scenario prompt includes an emergency or non-emergency scenario to generate a series of responses by the customer which are provided back to the provider across the link; and
a summary having at least one of an activity, article/periodical, and/or product to recommend a solution to a vulnerability identified by the provider based, at least in part, on the completion of the scenario prompt that may include the means, relationships and/or industry know-how to perform the follow-on activities.

2. The system of claim 1, wherein the summary further includes:
a first activity that recommends solutions to the scenario prompt in response to the series of responses sent across the link.

3. The system of claim 2, wherein the first activity teaches the customer to perform actions quick in response to the identified vulnerability.

4. The system of claim 3, wherein the first activity teaches employees of the customer to leave their belongings behind in the event of an emergency.

5. The system of claim 1, wherein the summary includes:
a recommendation for a product that reduces the likelihood of damage from the identified vulnerability.

6. The system of claim 1, wherein the summary includes:
reading materials for the customer to read on topics pertaining to the identified vulnerability.

7. The system of claim 1, wherein the summary includes:
an activity to be performed by persons associated with the customer subsequent the scenario prompt operative to further teach the persons associated with the customer to take appropriate actions in response an event in which the identified vulnerability actually occurs.

8. The system of claim 1, further comprising:
an implementation plan to including steps for the customer to implement recommendations from the provider in the summary, wherein the implementation plan is generated in response to the series of responses by the customer or participants under direction of the customer.

9. The system of claim 8, further comprising:
wherein the provider generates the implementation plan through an analysis of capabilities taken from predefined goals and evaluation of participant responses of the customer from the role-playing scenario and details the participant responses relative to the predetermined goal; and
wherein the analysis of capabilities details observations recorded by the participants during the role-playing scenario relevant to core capabilities and the core capabilities may be selected from a group comprising planning, situational assessment, risk and disaster resilience, and public information and warning.

10. The system of claim 9, further comprising:
planning capabilities configured to conduct a systematic process engaging the customer as appropriate in the development of executable strategic, operational, or tactical level approaches to meet defined objectives.

11. The system of claim 10, further comprising:
a first set of objectives in the implementation plan;
a second set of objects in the implementation plan;
wherein the first set of objects recognize vulnerabilities at a location determined by the customer;
wherein the first set of objectives have an associated core capability of situational awareness and planning.

12. The system of claim 11, further comprising:
a first subset of the first set of objectives, wherein the first subset is an organization and leadership subset; and
a second subset of the first set of objectives, wherein the second subset is a planning and personnel subset.

13. The system of claim 12, further comprising:
at least one recommendation provided by the provider to the customer within the implementation plan for issues and areas for improvement associated with the first subset and second subset.

14. The system of claim 13, further comprising:
a list of necessities provided by the provider to the customer to make the location less vulnerable to the identified vulnerability.

15. The system of claim 10, further comprising:
a third set of objectives in the implementation plan.

16. The system of claim 8, further comprising:
a business impact analysis provided to the customer by the provider in response to completion of the scenario prompt that effectuates the customer to implement the implementation plan.

17. The system of claim 16, further comprising:
goals added to the implementation plan by the customer to be completed within a specific timeframe.

18. The system of claim 17, wherein the implementation plans includes recommendations populated from customer responses to the scenario prompt.

19. The system of claim 18, further comprising:
a table comprising cells to be populated by the customer in accordance with a predetermined legend or key, wherein the table is adapted for the customer to use the key to evaluate whether the recommendations are appropriately described and evaluated.

20. The system of claim 19, wherein at least one cell of the table is associated with an existing rating that the customer perceived as the recommendation, and wherein the table further includes:
at least one cell relating to a project rating for when customer completes implementing the recommendation.

21. A method for identifying emergency or non-emergency vulnerabilities comprising:
providing a role-playing scenario to a customer across a link for the customer to execute;
receiving data responses generated by the customer in response to execution of the role-playing scenario;
analyzing the data response for vulnerabilities that the customer identified during execution of the role-playing scenario and summarizing the data response in a summary; and
providing in the summary, to the customer across the link, an action call recommendation that includes one of a product to purchase, a periodical to read, a video to watch, and an activity to perform adapted to mitigate or remediate one or more of the emergency or non-emergency vulnerabilities.

22. The method of claim 21, further comprising:
accumulating responses from the customer across the link until a sufficient amount of responses has been accumulated to generate the action call recommendation.

23. The method of claim 21, further comprising:
blocking and removing outlier responses provided during the execution of the role-playing scenario.

24. The method of claim 21, further comprising:
commanding a customer to improve a physical or virtual facility subsequent to execution of the role-playing scenario.

25. The method of claim 21, further comprising:
compressing, digitally, the summary prior to sending the summary to the customer across the link.

26. The method of claim 21, further comprising:
customizing the summary for addressing the emergency and non-emergency vulnerabilities in response to the data responses generated during the role-playing scenario.

27. The method of claim 21, further comprising:
deriving the action call recommendations from a database of available action call recommendations stored in at least one non-transitory computer readable storage medium located remotely from a physical or virtual facility of the customer; and
differentiating one action call recommendations from another action call recommendation in the summary;
displaying the differentiated action call recommendations in the summary;
embedding links in the summary to wireless link connect the customer with an item associated with one response action call recommendation; and
distributing the summary over the link.

28. The method of claim 21, further comprising:
altering, dynamically, the summary in response to receiving multiple sets of data response from the customer provided across the link.

29. The method of claim 21, further comprising:
financing a portion of the summary with advertising revenue from a third party associated with at least one product recommended to the customer in one of the action call recommendations provided across the link.

30. The method of claim 21, further comprising:
pre-determining, prior to generating the summary, a set of action call recommendations that will be recommended in the summary based on the role-playing scenario executed by the customer.

31. The method of claim 21, further comprising:
rating, in the summary, an effectiveness of the action call recommendations for the customer based on a rating system independent from the customer.
